(19) United States
(12) Patent Application Publication
(10) Pub. No.: US 2025/0165696 A1
(43) Pub. Date: May 22, 2025

(54) INTEGRATED TWO-FRAME EBOOK/MEDIA PLATFORM

(71) Applicant: Thomas Francis Arant, Dallas, TX (US)

(72) Inventor: Thomas Francis Arant, Dallas, TX (US)

(21) Appl. No.: 18/513,019

(22) Filed: Nov. 17, 2023

(51) Int. Cl. G06F 40/166; G06F 40/117; G10L 13/00

(52) U.S. Cl. CPC G06F 40/166; G06F 40/117; G10L 13/00

(57) ABSTRACT

A downloaded text file of a publication is viewable in first user interface. A media file related to the text of the downloaded text file and executable instruction is received. A point in the text is tagged with the received executable instruction. The executable instruction performs a dynamic change in the media file when the downloaded text is read in a digital readable format of a digital book. The executable instruction is performed in the digital readable format upon a triggering event associated with the tagged point in the text. Performing the executable instruction performs a display of the dynamic change in the media file in the digital book format.

### CROSS-REFERENCE TO RELATED APPLICATIONS

None.

### FIELD OF THE INVENTION

The present invention relates to, digital books, and more particularly, to the integration of dynamic media capabilities with associated eBook media tags and media behavior executables that control behavior in side-by-side text and media frames operating on eBook/tablet platforms along with its associated development environment.

### BACKGROUND

The background information herein below relates to the present disclosure but is not necessarily prior art.

The embodiments herein relate generally to interface and interaction techniques using an integrated two-frame eBook/media platform (I2FEMP).

With any book (paper or digital), when the context references a factual or fictional geographic location and associated events, the spatial locations and temporal events within the geographic context are described textually and sometimes supplemented with one or more static maps. The associated events are also described to the extent chosen by the author. The textual information is insufficient to provide a comprehensive understanding of the events to the reader for many reasons.

When there are one or more associated maps and associated events within a paper or digital book,
The maps represent the author's best opinion on what static images would supplement the text to enhance the reader experience.
Because these static images are displayed individually, going back and forth between the text and images is necessary for viewing. The reader finds it challenging to visualize what is being represented because of the back-and-forth flipping.
The maps require much effort to visualize what is being represented.
The maps are static, which makes it difficult to envision movements of maps and objects such as journeys and battles.
The maps lack the ability to obtain further spatial and temporal information by manipulation.

When there is a contemporary or historical location and associated events referenced either in the text or map, it may not be familiar to the reader, and further research requires that the reader reference an external data source.

eBook digital interfaces provide the additional capability to perform freeform, ad hoc searches for additional information through highlighting eBook text that searches for Wikipedia entries or initiates a Web search. This requires the eBook consumer to leave the eBook interface to view the Wikipedia entries or search results.

Similarly, an eBook consumer must leave the current reading location to view eBook figures, tables, and endnotes, and then manually return to the reading location.

Therefore, there is felt a need for an environment for authoring and an environment for consuming this content that alleviates the aforementioned drawbacks.

### SUMMARY OF THE INVENTION

According to an embodiment of the present disclosure, a computer program product for generating enhanced media in a digital book is disclosed. The computer program product comprises a non-transitory computer readable storage medium having computer readable program code embodied therewith. The computer readable program code is configured, when executed by a processor, to receive a downloaded text file of a publication. A first user interface is generated. Text of the downloaded text file is viewable by a user in the first user interface. A media file related to the text of the downloaded text file is received. A point in the text is tagged. An executable instruction embedded in the tagged point in the text is received. The executable instruction performs a dynamic change in the media file. The downloaded text is displayed in a digital readable format. The downloaded text incorporates the executable instruction in the tagged point along with the media file in the digital book. In addition, the executable instruction is performed upon a triggering event associated with the tagged point in the text. Performing the executable instruction performs a display of the dynamic change in the media file in the digital book format.

In another embodiment of the disclosure, a user interface platform for digital books is disclosed. The platform includes a first user interface. The first user interface includes a digital book download portal, and a media development interface. An author user generates a media file or modifies a pre-generated media file in the first user interface that includes content associated with a digital book downloaded through the digital book download portal. The platform also includes a second user interface. The second user interface includes a first frame displaying text of the digital book downloaded through the digital book download portal and displays the author user generated media file or modified pre-generated media files.

### BRIEF DESCRIPTION OF THE DRAWINGS

FIG. 1 is a block diagram of an integrated two-frame eBook/media platform, including the author and consumer hardware and software environments, in accordance with an embodiment of the present disclosure.

FIG. 2 is a flowchart of a process for generating an integrated two-frame eBook/media platform content, in accordance with an embodiment of the present disclosure.

FIG. 3 is a block diagram of the author environment of the an integrated two-frame eBook/media platform of FIG. 1, in accordance with an embodiment of the present disclosure.

FIG. 4 is a flowchart of a method for the creation of the content by the author to be consumed in the integrated two-frame eBook/media platform consumer environment, in accordance with an embodiment of the present disclosure.

FIG. 5 is a block diagram of the consumer environment of the integrated two-frame eBook/media platform for displaying text within the text frame and map within the Media Frame on a tablet/eBook platform, in accordance with an embodiment of the present disclosure.

FIG. 6 is a flowchart of a method of consumer interaction of the content created by the integrated two-frame eBook/media platform author environment, in accordance with an embodiment of the present disclosure.

FIG. 7 is a screenshot of a user interface displaying the cover page of an eBook consistent with embodiments of the present disclosure.

FIG. 8 is a screenshot of a user interface displaying eBook content generated by the integrated two-frame eBook/media platform, in accordance with an embodiment of the present disclosure.

FIG. 9 is a screenshot of a user interface displaying eBook content generated by the integrated two-frame eBook/media platform, in accordance with an embodiment of the present disclosure.

FIG. 10 is a screenshot of a user interface displaying eBook content generated by the integrated two-frame eBook/media platform, in accordance with an embodiment of the present disclosure.

FIG. 11 is a screenshot of a user interface displaying eBook content generated by the integrated two-frame eBook/media platform, in accordance with an embodiment of the present disclosure.

FIG. 12 is a screenshot of a user interface displaying eBook content generated by the integrated two-frame eBook/media platform, in accordance with an embodiment of the present disclosure.

FIG. 13 is a screenshot of a user interface displaying eBook content generated by the integrated two-frame eBook/media platform, in accordance with an embodiment of the present disclosure.

FIG. 14 is a screenshot of a user interface displaying eBook content generated by the integrated two-frame eBook/media platform, in accordance with an embodiment of the present disclosure.

FIG. 15 is a screenshot of a user interface displaying eBook content generated by the integrated two-frame eBook/media platform, in accordance with an embodiment of the present disclosure.

FIG. 16 is a screenshot of a user interface displaying eBook content generated by the integrated two-frame eBook/media platform, in accordance with an embodiment of the present disclosure.

FIG. 17 is a screenshot of a user interface displaying eBook content generated by the integrated two-frame eBook/media platform, in accordance with an embodiment of the present disclosure.

FIG. 18 is a screenshot of a user interface displaying the cover page of an eBook consistent with embodiments of the present disclosure.

FIG. 19 is a screenshot of a user interface displaying eBook content generated by the integrated two-frame eBook/media platform, in accordance with an embodiment of the present disclosure.

FIG. 20 is a screenshot of a user interface displaying eBook content generated by the integrated two-frame eBook/media platform, in accordance with an embodiment of the present disclosure.

FIG. 21 is a screenshot of a user interface displaying eBook content generated by the integrated two-frame eBook/media platform, in accordance with an embodiment of the present disclosure.

FIG. 22 is a screenshot of a user interface displaying the cover page of an eBook consistent with embodiments of the present disclosure.

FIG. 23 is a screenshot of a user interface displaying eBook content generated by the integrated two-frame eBook/media platform, in accordance with an embodiment of the present disclosure.

FIG. 24 is a screenshot of a user interface displaying eBook content generated by the integrated two-frame eBook/media platform, in accordance with an embodiment of the present disclosure.

FIG. 25 is a screenshot of a user interface displaying eBook content generated by the integrated two-frame eBook/media platform, in accordance with an embodiment of the present disclosure.

FIG. 26 is a screenshot of a user interface displaying eBook content generated by the integrated two-frame eBook/media platform, in accordance with an embodiment of the present disclosure.

FIG. 27 is a screenshot of a user interface displaying the cover page of an eBook consistent with embodiments of the present disclosure.

FIG. 28 is a screenshot of a user interface displaying eBook content generated by the integrated two-frame eBook/media platform, in accordance with an embodiment of the present disclosure.

FIG. 29 is a screenshot of a user interface displaying eBook content generated by the integrated two-frame eBook/media platform, in accordance with an embodiment of the present disclosure.

FIG. 30 is a screenshot of a user interface displaying the cover page of an eBook consistent with embodiments of the present disclosure.

FIG. 31 is a screenshot of a user interface displaying eBook content generated by the integrated two-frame eBook/media platform, in accordance with an embodiment of the present disclosure.

FIG. 32 is a screenshot of a user interface displaying eBook content generated by the integrated two-frame eBook/media platform, in accordance with an embodiment of the present disclosure.

FIG. 33 is a screenshot of a user interface displaying the cover page of an eBook consistent with embodiments of the present disclosure.

FIG. 34 is a screenshot of a user interface displaying eBook content generated by the integrated two-frame eBook/media platform, in accordance with an embodiment of the present disclosure.

FIG. 35 is a screenshot of a user interface displaying eBook content generated by the integrated two-frame eBook/media platform, in accordance with an embodiment of the present disclosure.

FIG. 36 is a screenshot of a user interface displaying eBook content generated by the integrated two-frame eBook/media platform, in accordance with an embodiment of the present disclosure.

FIG. 37 is a screenshot of a user interface displaying eBook content generated by the integrated two-frame eBook/media platform, in accordance with an embodiment of the present disclosure.

FIG. 38 is a screenshot of a user interface displaying eBook content generated by the integrated two-frame eBook/media platform, in accordance with an embodiment of the present disclosure.

FIG. 39 is a screenshot of a user interface displaying eBook content generated by the integrated two-frame eBook/media platform, in accordance with an embodiment of the present disclosure.

### LIST OF REFERENCE NUMERALS USED IN DETAILED DESCRIPTION AND DRAWING

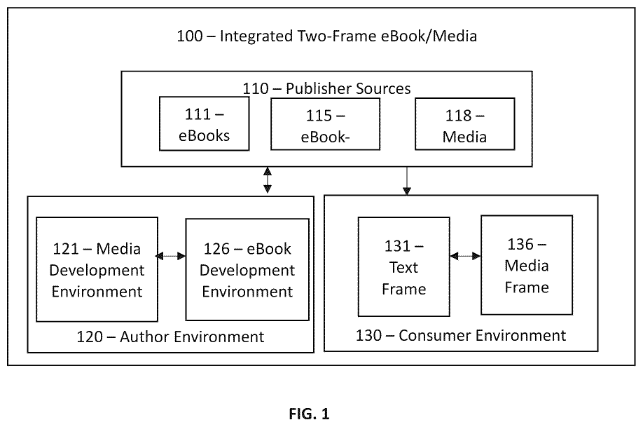

FIG. 1—Integrated Two—Frame eBook/Media Platform (I2FEMP) Block Diagram
100—Integrated Two—Frame eBook/Media Platform
110—Publisher Sources
111—eBooks
115—eBook—Specific Media
118—Media Ecosystem
120—Author Environment
121—Media Development Environment
126—eBook Development Environment
130—Consumer Environment
131—Text Frame
136—Media Frame

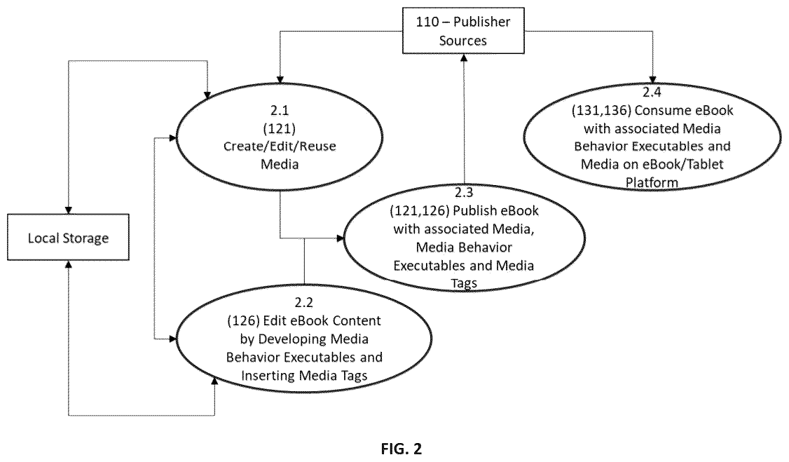

### FIG. 2—I2FEMP End-to-End Process Flow Diagram

2.1 Create/Edit/Reuse Media
2.2 Edit eBook Content by Developing Media Behavior Executables and Inserting Media Tags
2.3 Publish eBook with associated Media Behavior Executables and Media Tags
2.4 Consume eBook with associated Media on eBook/Tablet Platform

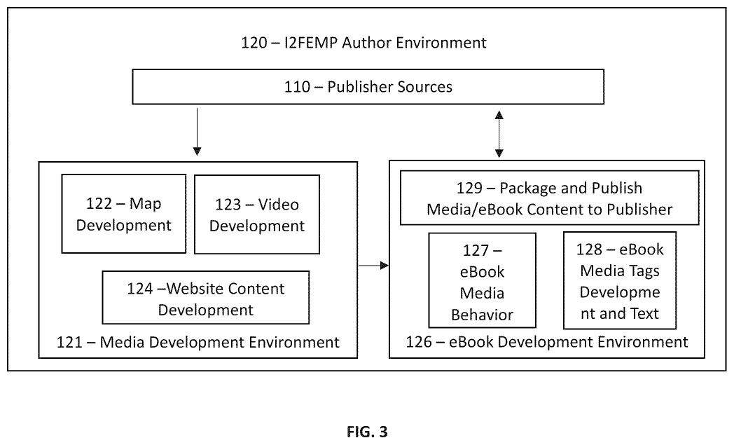

### FIG. 3—I2FEMP Author Environment Block Diagram

110—Publisher Sources
120—I2FEMP Author Environment
121—Media Development Environment
122—Map Development
123—Video Development
124—Website Content Development
126—eBook Development Environment
127—eBook Media Behavior Executables Development
128—eBook Media Tags Development and Text Insertion

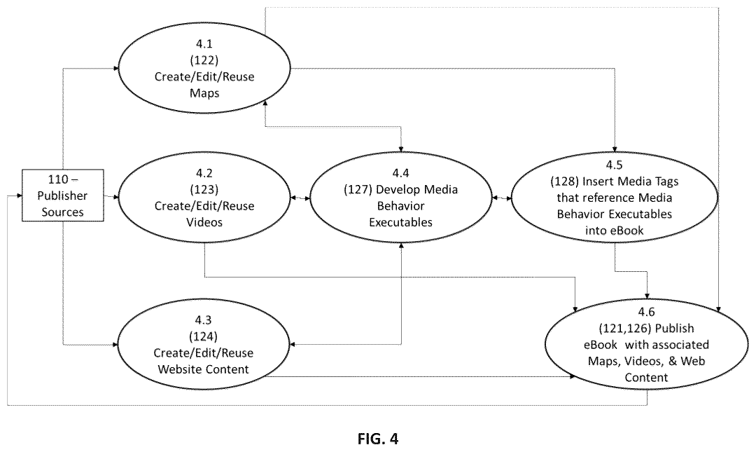

### FIG. 4—I2FEMP Author Environment Process Flow Diagram

4.1 Create/Edit/Reuse Maps
4.2 Create/Edit/Reuse Videos
4.3 Create/Edit/Reuse Website Content
4.4 Develop Media Behavior Executables
4.5 Insert Media Tags that reference Media Behavior Executable into eBook
4.6 Publish eBook with associated Maps, Videos, & Website Content

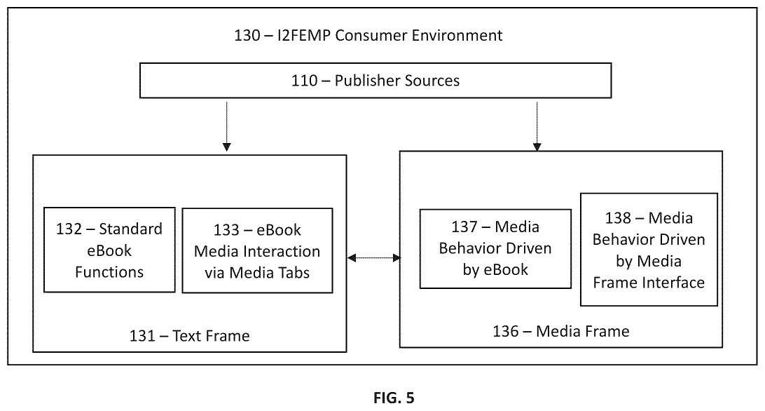

### FIG. 5—I2FEMP Consumer Environment Block Diagram

110—Publisher Sources
130—I2FEMP Consumer Environment
131—Text Frame
132—Standard eBook Functions
133—eBook Media Interaction via Media Tags
136—Media Frame
137—Media Behavior Driven by eBook Selection
138—Media Behavior Driven by Media Frame Interface

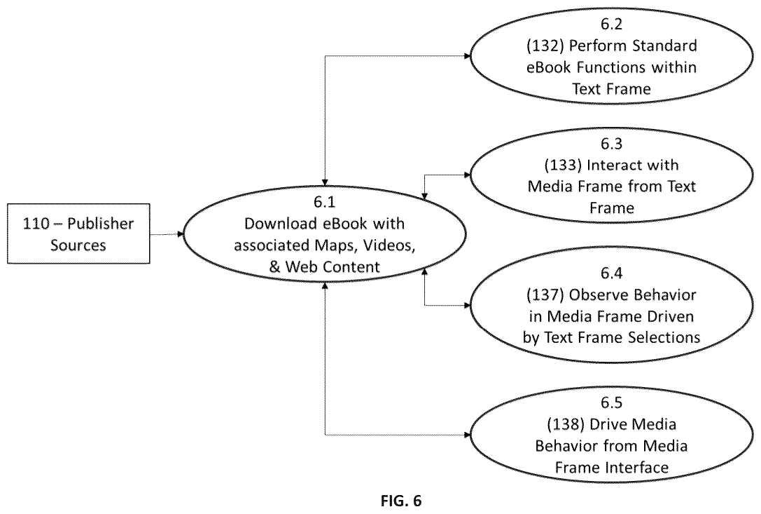

### FIG. 6—I2FEMP Consumer Environment Process Flow Diagram

6.1 Download eBook with associated Maps, Videos, & Website Content
6.2 Perform Standard eBook Functions within Text Frame
6.3 Interact with Media Frame from Text Frame
6.4 Observe Behavior in Media Frame Driven by Text Frame Selections
6.5 Drive Media Behavior from Media Frame Interface

### DETAILED DESCRIPTION OF CERTAIN EMBODIMENTS

Embodiments of the present disclosure will now be described with reference to the accompanying drawings.

Embodiments are provided so as to thoroughly and fully convey the scope of the present disclosure to the person skilled in the art. Numerous details are set forth, relating to specific components and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used in the present disclosure is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, elements, modules, units, and/or components, but do not forbid the presence or addition of one or more other features, elements, components, and/or groups thereof.

### Definitions

The following terms are defined to assist the reader in comprehending some aspects of the present disclosure. The following is not necessarily an exhaustive set of terms defined. Some terms may be defined by clarifying language present below.

Spatiotemporal—Of or relating to space and time together (having both spatial dimensions and temporal instance/duration).

Frame—A tablet/eBook window. The term “Frame” means that a window in a user interface is side-by-side with another window, e.g., the Text Frame with eBook text content and functionality is side-by-side with the Media Frame containing relevant media and associated functionality in some embodiments.

Media—Any visualization supported by and appearing in the media frame in the integrated two-frame eBook/media platform (I2FEMP), including, but not limited to:
Maps
Map Animations
Map-Synchronized Audio Narration
eBook Figures, Tables, and Endnotes
Videos
Websites

Map—A graphic representation of the spatial relationships of geographical information and entities within an area.

Dynamic Spatiotemporal Mapping—A graphical technique to represent the evolution of data with time and space during a process, event, or animation.

Visualization—The actual appearance of a given map.

Map Animation—A graphical technique to represent a map changing its spatial view and/or temporal representation with or without objects moving through that space and time on a map layer, aka a temporal event. From ESRI GIS Dictionary—“a collection of animation tracks that define the dynamic property changes to associated objects. An animation allows for navigation through the display, visualization of temporal changes, or alteration of layer and scene properties, such as layer transparency or the scene background.”

Audio Narration—There are two types of audio narration envisioned with this present disclosure—Text-Synchronized and Map-Synchronized:

Text-Synchronized Audio Narration—Narration that refers to the technology whereby eBook text is synchronized with narration, e.g., audible narration on the Amazon Kindle. This text-synchronized audio narration may also be synchronized with behavior within the media frame initiated by eBook media tags.

Map-Synchronized Audio Narration—Narration that refers to audio narration associated with a static map or a map with animation displayed in the media frame.

eBook Figures, Tables, and Endnotes—Figures, tables, and endnotes found within eBook content.

Author—Someone who creates content within the I2FEMP, whether it be text, audio narration, maps, animation, figures, or any other form.

Consumer—Someone who uses the tablet/eBook device within the I2FEMP to consume the text in the Text Frame, listen to audio, and observe/control media frame behavior.

Media Tag—Code embedded within an eBook's content that, when selected within the text frame, executes its associated media behavior executable that initiates behavior within the media frame.

Media Tag Representation—A word with a special font, superscript, or adjacent icon that represents the location of media tags in the eBook content. The exact form of this representation has not yet been determined. It is this representation that the consumer would select to initiate the associated media behavior executable.

Media Behavior Executable—Programming code that, when executed by selecting its associated media tag in an eBook within the text frame, initiates media behavior dependent on the type of media within the media frame. Behavior includes:
Maps—setting map conditions, loading data.
Map Animations—controlling map animation.
Map-Synchronized Audio Narration—controlling map-synchronized audio narration.
eBook Figures, Tables, and Endnotes—displaying figures, tables, and endnotes.
Videos—starting and stopping videos.
Websites—displaying/controlling website pages.
   Map Condition—Map characteristics, including visible extent, scale, level of detail within the scale range, displayed elements/layers, and temporal point in time.

Embodiments of the subject platform and system include two environments: consumer and author.

### Author Environment

The author environment is a software development environment made up of a set of software applications whereby an author can create, reuse, and publish spatiotemporal maps in a mapping application, animations in an animation application, map-synchronized narration in a narration application, videos in a video application, and website content in a website development application that represent media referred to in eBook text. In the author environment, a user may also create and add embedded media tags into eBook text with associated media tags representations.

Using a software development application, a user can create and publish media behavior executables in the author environment that execute associated media behavior within the media frame when media tags representations of media tags embedded in eBook content are selected in the text frame. The author environment may include one or more features through which the user may create and publish media behavior executables that display existing eBook figures, tables, and endnotes based on selecting associated media tags.

In some embodiments, the author environment may include an eBook editor application, through which the user creates/inserts media tags at the appropriate locations withing the eBook text. Using an eBook editor application, the user may create media tag representations that represent the location of media tags in the eBook content via for example, a special font, superscript or icon. The user may select the representation to initiate the associated media behavior executable.

The author environment may publish the eBook content (including any figures, tables, and endnotes) with embedded media tags, media tag representation, associated media behavior executables, spatiotemporal maps, animations, map-synchronized narrations, videos, and website content output of the author environment to Kindle Direct Publishing (KDP), Apple Books for authors, B&N Press, and other eBook publishing platforms for consumption within the consumer environment.

### Consumer Environment

The consumer environment is a software environment running on eBook/tablet platforms that integrates eBook content shown within a text frame, and optionally text-synchronized audio narration associated with the eBook text, with a media environment in a separate side-by-side media frame that supports the display and manipulation of maps, videos, & website content. Existing eBook figures, tables, and endnotes are also supported for displayed in the media frame. The consumer environment consumes the output of the author environment as published and downloaded. Within the consumer environment, a consuming user, (sometimes referred to as the “consumer” or “reader”), can choose between single or side-by-side text and media frames. For example, the text frame and the media frame may be displayed juxtaposed on the same screen (next to each other displayed as either vertical frames splitting a screen or horizontal frames) and displaying content in one frame that relates to content displayed in the other frame. Or the user may select an option to display only the text frame or only the media frame in the display.

Within the consumer environment, the consumer can initiate actions in the media frame by selecting media tag representations embedded within eBook text within the text frame. Within the consumer environment, a download function allows the consumer to acquire and download an eBook (including any figures, tables, and endnotes) with associated embedded media tags, media tag representation, associated media behavior executables, spatiotemporal maps, animations, map-synchronized narration, videos, and website content using an equivalent process used today to acquire and download eBook and audio content. In some embodiments, the consumer environment media frame may include a map acquisition module, where the consumer may directly search for, select, acquire, download, and manage spatiotemporal maps, animations, map-synchronized narration, videos, and website content from publisher sources. Within the consumer environment running on an eBook/tablet platform, existing standard eBook functionality would not be reduced, only enhanced.

Referring now to FIG. 1, an integrated two-frame eBook/media platform 100 is shown according to an embodiment. The platform includes two environments: author environment 120 and consumer environment 130. Both environments interface with publisher sources 110 (which may be external from the platform) to publish and obtain eBooks, spatiotemporal maps, animations, map-synchronized narrations, videos, and website content. In some embodiments, the publisher sources 110 include traditional sources for publishing, purchasing, and downloading eBooks 111, (for example, Amazon's® Kindle® Direct Publishing). In some embodiments, the publisher sources 110 also include a class of publishing sources that support spatiotemporal maps, animations, map-synchronized narrations, videos, and website content. These spatiotemporal maps, animations, map-synchronized narrations, videos, and website content may be developed specifically for individual eBooks (represented by eBook-specific media 115) or for retrieval and common use across multiple eBooks (represented by the media ecosystem 118).

The author environment 120 includes software applications and interfaces necessary to develop spatiotemporal maps, animations, map-synchronized narrations, videos, and website content, and media behavior executables that trigger media behavior (media development environment 121). The author environment 120 also has a function that allows users to create media tags within eBook content that are uniquely associated with media behavior executables to enable dynamic map illustrations, animation, and narration behavior, either eBook-specific or from publicly available sources in the maps ecosystem (eBook development environment 126). Some embodiments include a user application within the mapping development environment 121 to create or reuse spatiotemporal maps, animations, map-synchronized narrations, videos, and website content. Some embodiments include an application within the mapping development environment 121 to create media behavior executables that control these spatiotemporal maps, animations, map-synchronized narrations, videos, and website content in the media frame. The eBook development environment 126 may include an eBook editing feature to create media tags within the eBook text that control the spatiotemporal maps, animations, map-synchronized narrations, videos, and website content by association with media behavior executables.

Referring still to FIG. 1, the consumer environment 130 includes a text frame 131 and a media frame 136. The consumer environment 130 includes applications and user interfaces running on eBook/tablet platforms that integrate the text within the text frame 131 with map enhancing features. Some embodiments include text-synchronized audio narration, of an eBook with a media environment within the media frame. The hardware/software platform utilizes media tags embedded within the text of eBooks (sometimes displayed as media tag representations) in the text frame to run media behavior executables that initiate for example, spatiotemporal maps, animations, map-synchronized narrations, videos, and website content behavior within the media frame 136. In some embodiments, the media frame 136 may include navigation tools in a user interface for a user to navigate independently of the text. The navigation commands in the media frame 136 user may be specific to each media type. The selection of media tag representations of eBook text displayed in the text frame 131 triggers behavior in the media frame 136 according to instructions in the media behavior executables.

FIG. 2 shows the I2FEMP end-to-end process flow containing the following processes. In FIG. 2, block 2.1, a create/edit/reuse media process includes receiving output by a computer processor, of one or more software applications to create, edit, and reuse spatiotemporal maps, animations, map-synchronized narrations, videos, and website content for eventual consumption by a consumer on an eBook/tablet platform. Block 2.2, edit eBook content by developing media behavior executables and inserting media tags includes receiving output by a computer processor, of one or more software applications that create media behavior executables and an eBook content editor. Media tags may be inserted in the text sections of the text frame 131 that call those executables into operation at appropriate locations in an eBook for consumption by a consumer on an eBook/tablet platform. Block 2.3, publish eBook with associated media, media behavior executables and media tags includes receiving by a computer processor, a command from the author to a publisher's web interface to upload eBook content that contains media tags with associated spatiotemporal maps, animations, map-synchronized narrations, videos, website content, and media behavior executables for eventual purchase and download to an eBook/tablet platform by a consumer. In block 2.4, Consume eBook with associated media behavior executables and media on eBook/tablet platform includes receiving by a computer processor, a download request from the consumer of an eBook with associated media behavior executables and media to an eBook/tablet platform. Text frame 131 and media frame 136 functions are performed to enable consumption of the content on that eBook/tablet platform.

The preferred embodiment of a system of the present disclosure will now be described in detail with reference to the diagrams shown in FIGS. 3 through 6. The preferred embodiment does not limit the scope and ambit of the present disclosure.

FIG. 3 illustrates a block diagram of the author environment 120 in more detail for creating an I2FEMP using a desktop computer platform intended for download and consumption on an eBook/tablet platform in accordance with a preferred embodiment of the present disclosure. In the author environment 120, spatiotemporal maps, animations, map-synchronized narrations, videos, and website content may be built using the media development environment 121. The spatiotemporal maps, animations, map-synchronized narrations, videos, and website content may be associated with eBook text through the creation of media behavior executables, eBook insertion of media tags, and a package upload to publisher sources using the eBook development environment 126.

In FIG. 3, within the media development environment 121, a user interface includes selectable features to build spatiotemporal maps, animations, map-synchronized narrations (through map development interface 122), videos (through map animation development module 123), and website content (through website content development module 124). The map development environment 122 may include use of one or more commercially-available mapping applications that will support the development of spatiotemporal maps, animations, and map-synchronized narrations. The video development environment 123 may include use of one or more commercially-available animation applications that will create videos. The website content development environment may include use of one or more commercially-available animation applications that will create websites.

The eBook development environment 126 is configured to support the development of media behavior executables that control behavior in the media frame 136 (through eBook media behavior executables development module 127). The eBook development environment 126 will also support the development and insertion of media tags that are associated with media behavior executables. The media tags may be inserted into the applicable eBook content locations to support the triggering of specific media behavior initiated by media tags upon selection (using for example, the eBook media development and text insertion interface 128). The eBook development environment 126 may support the packaging and publishing of an eBook with any associated media, including spatiotemporal maps, animations, map-synchronized narrations, videos, and website content links (using for example, the package and publish media/eBook content to publisher sources module 129).

FIG. 4 represents the I2FEMP author environment process flow containing the following processes. In block 4.1, create/edit/reuse maps includes receiving output by a computer processor, from a desktop application that creates, edits, and reuses spatiotemporal maps, animations, and map-synchronized narrations as directed by the author. Maps already existing for reuse may be downloaded from the publisher sources 110. In block 4.2, create/edit/reuse videos includes receiving output by a computer processor, from a desktop application to create, edit, and reuse videos as directed by the author. Videos already existing for reuse may be downloaded from publisher sources 110. In block 4.3 create/edit/reuse website content includes receiving output by a computer processor, from a desktop application to create, edit, and reuse website content as directed by the author. Website content already existing for reuse may be downloaded from publisher sources 110. Block 4.4 develop media behavior executables includes receiving output by a computer processor, from a software development application operated by the author to create media behavior executables designed to initiate specific behavior in the media frame. Block 4.5 insert media tags that reference media behavior executables into eBook includes receiving output by a computer processor, from an eBook editing application operated by the author, to insert media tags that reference media behavior executables into an eBook. Block 4.6 publish eBook with associated maps, videos, & web content includes receiving by a computer processor, a command from the author to upload/publish maps, animations, and narration spatiotemporal maps, animations, map-synchronized narrations, videos, and website content with an associated eBook to a publisher site. The eBook would include the inserted media tags with associated media behavior executables

FIG. 5 illustrates a block diagram of the consumer environment 130 in more detail, for consuming an I2FEMP instance (i.e., specific eBooks containing media tags and media behavior executables with associated spatiotemporal maps, animations, map-synchronized narrations, videos, and website content) running on an eBook/tablet platform in accordance with a preferred embodiment of the present disclosure. In one embodiment, the consumer environment 130 includes the text frame 131. The text frame 131 displays the eBook content downloaded from the publisher sources 110, which is then manipulated by the interaction of end users through the media frame 136. The consumer environment 130 also includes the media frame 136 which, displays and provides interaction with spatiotemporal maps, animations, map-synchronized narrations, videos, website content, and eBook figures, tables, and endnotes.

The consumer environment 130 may include consumer-selected portrait orientation and landscape orientation modes of visualization, wherein the portrait orientation places the text frame above the mapping frame, while the landscape orientation places the text frame to one side of (e.g., the left) of the media frame 136. In the consumer environment 130, the user interaction includes activation of the media frame 136 behavior from media tags. The media tags may be visually identified by media tag representations contained within eBook content in the text frame 131. When a media tag representation is selected by the consumer, media behavior executable instructions associated with the media tag representation are executed. Executable instructions that maybe embedded into the text may include loading the media frame 136, loading and executing media (including spatiotemporal maps, animations, map-synchronized narrations, videos, website content, and eBook figures, tables, and endnotes), and controlling media behavior. The media frame 136 and its content may also be executed independently by the consumer through the media frame user interface. Examples of interaction are provided below. The media tag representations within the text frame 131 may be selected manually to initiate behavior in the media frame 136. The media frame 136 may return the user to the first contextual location within the text frame 131 after the triggering behavior is completed.

FIG. 6 represents a consumer environment process including the following subprocesses. In block 6.1, a consumer user downloads associated maps, videos, and web content for an eBook from a publisher, including for example, any spatiotemporal maps, animation files, map-synchronized narrations, videos, and website content. In an embodiment, media files may be available online or downloaded to the eBook/tablet device via the same means that eBooks and text-synchronized audio narration are currently available and downloaded from publisher sources 110. In block 6.2, perform standard eBook functions within text frame includes the processor receiving standard eBook functionality commands within the text frame, including for example, browsing an eBook library and store, opening/closing an eBook, moving within the eBook, changing font types/sizes, and selecting text. In block 6.3, interact with media frame from text frame the process includes receiving a selection in the text frame by the processor, that initiates behavior in the media frame either by 1) selecting text links to endnotes, tables, or figures, 2) selecting text that then can initiate dictionary or Wikipedia® results, or 3) selecting a media tag representation that executes an associated media behavior executable. The media tag representation selections may be performed by user selection or automatically as a result of audio narration moving through the eBook text; for example, when audio narration reaches the point of insertion of a media tag representation, the associated media behavior executable is triggered. In block 6.4, observe behavior in media frame driven by text frame selections the consumer observes media frame behavior initiated from the text frame. In block 6.5, drive behavior from media frame interface, the processor may receive user input from the consumer as the consumer interacts directly with selectable features (buttons, menus, etc.) in the media frame using the media frame interface.

The content (including selectable features) in the media frame user interface may be dependent on what is being displayed in the media frame, whether it be spatiotemporal maps, animations, map-synchronized narrations, videos, website content, or eBook figures, tables, and endnotes. When displaying media, the media frame would utilize the system-default application associated with the media type.

In an embodiment, media behavior executables may be used to control the media content, wherein the media content is unique to an eBook, available in an ecosystem for reuse in multiple eBooks, or a combination thereof. Animations may be with or without map-synchronized audio narration describing the location/event portrayed. In an embodiment, reader (consumer) actions include for example, moving through the text frame via keyboard, mouse, or audio controls, and executing media frame behavior from the text frame by selecting media tag representations via keyboard, mouse, or text-synchronized audio controls.

In an embodiment, examples of mapping behavior that media behavior executables may perform includes: opening the media frame if not already open and repositioning the text/media frames side-by-side; loading base and layer maps; changing zoom level; changing location; changing time; selecting starting and subsequent views; turning layers with spatiotemporal (location/zoom and time) range on and off; following links to other maps or reference materials; initiating/controlling animations; and initiating/controlling map-synchronized audio narration clips.

In an embodiment, examples of video behavior that media behavior executables may perform includes: opening the media frame if not already open and repositioning the text/media frames side-by-side; loading the video; starting and stopping the video; controlling the video volume; and closing the media frame and repositioning the text frame to fill the screen.

Examples of eBook behavior performed in some embodiments includes: displaying eBook figures, tables, endnotes prompted by the selection of those links in the Text Frame; displaying dictionary results in the media frame based on the selection of text and the subsequent dictionary prompt in the text frame; and displaying Wikipedia® results in the media frame based on the selection of text and the subsequent Wikipedia prompt in the text frame.

Examples of map development actions include: designing and building maps specific to eBook content; reusing free or licensed compatible maps from a maps ecosystem module 118; designing and building spatiotemporal overlays; building map animations; associating map-synchronized audio narrations with eBook content and map animations; and publishing spatiotemporal maps, animations, map-synchronized narrations to the publisher sources.

Examples of map development module 122 menu commands includes: File Tools (New, Open, Save, Save As, Publish, Print, Export, Share, Close); Spatial Navigation Tools; Temporal Navigation Tools; Animation Tools; Audio Narration Tools; and Generate/Associate Map and Media Tags.

In another embodiment, eBook content may be in a Kindle® Format 8 (AZW3), electronic publication (EPUB3) format, or any EPUB format later than EBUB3 format.

### Sample Mockups of I2FEMP Consumer Environment

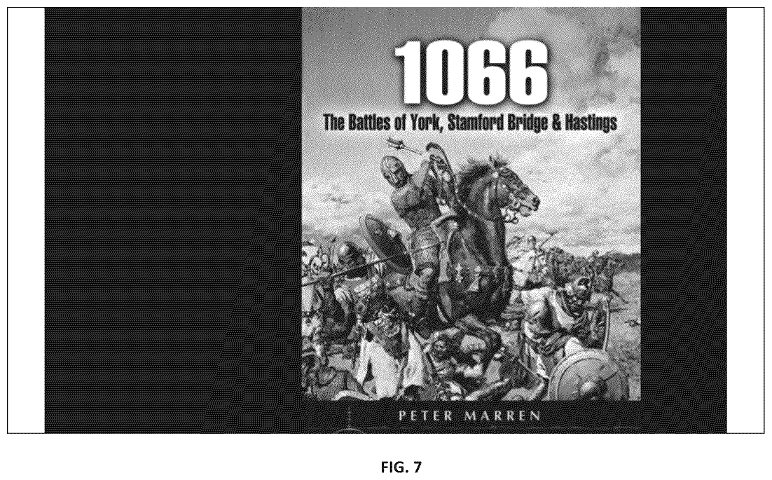

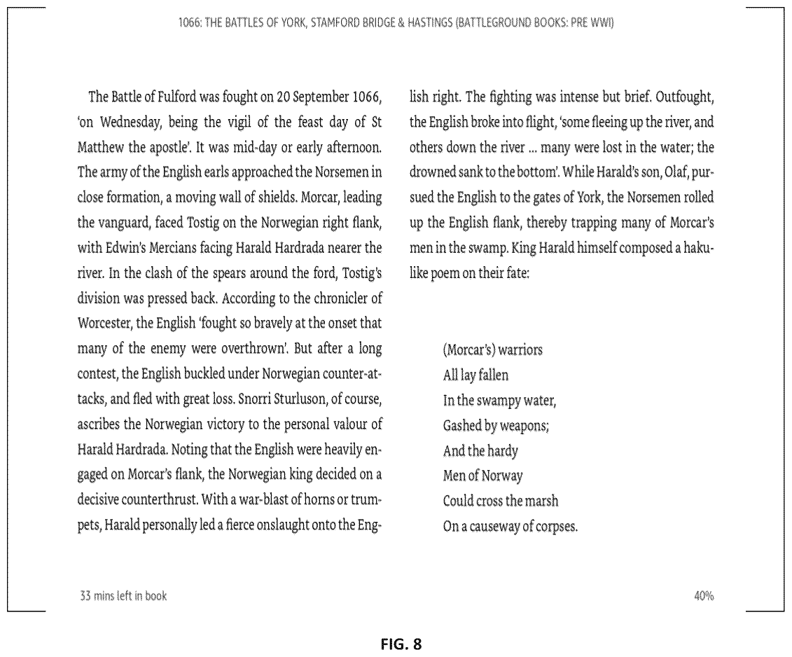

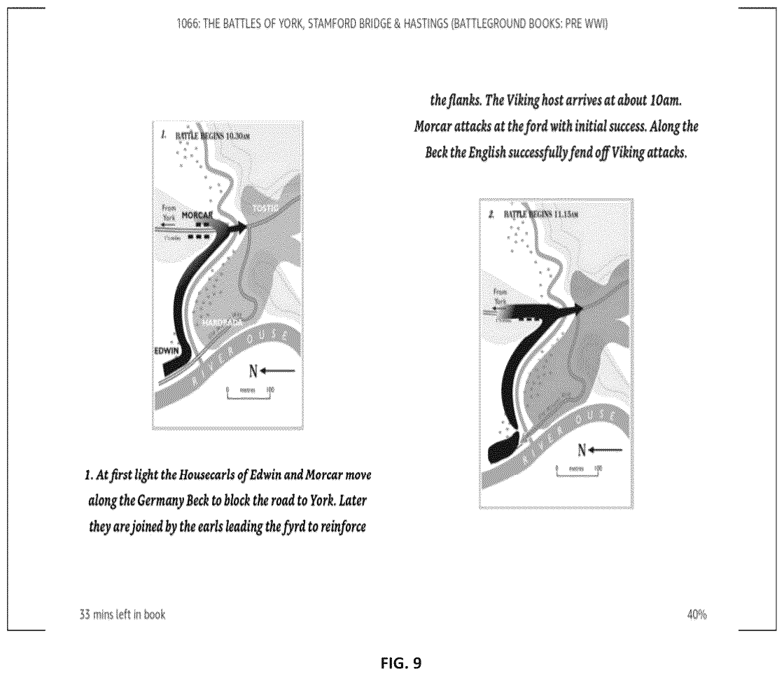

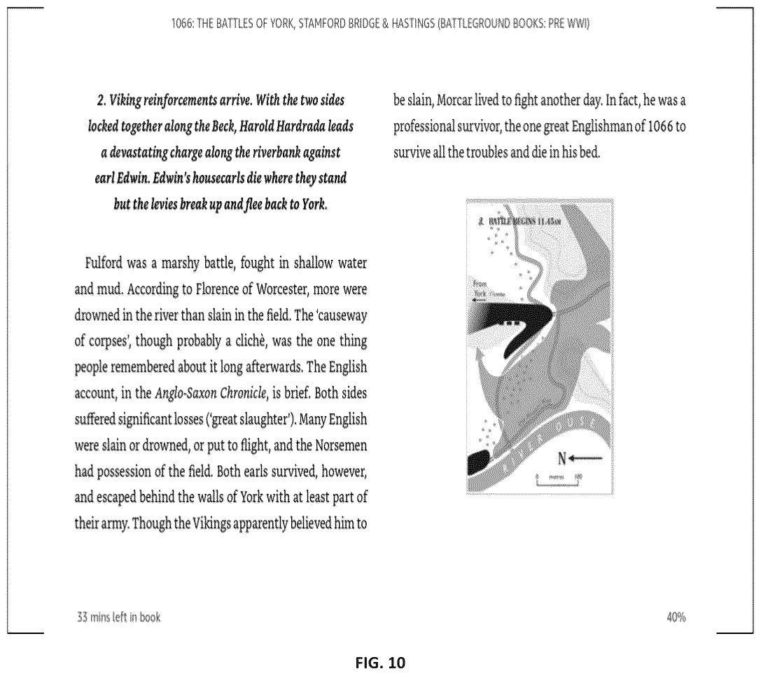

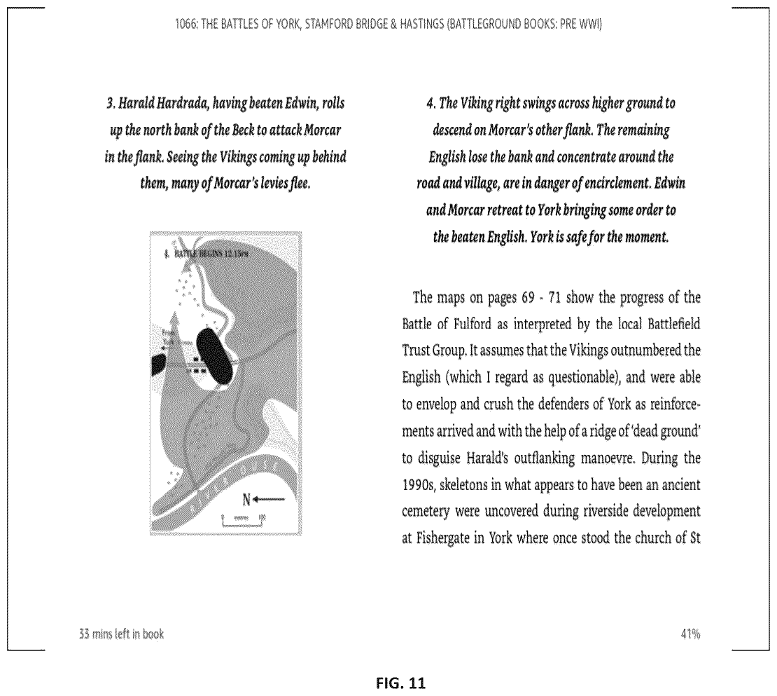

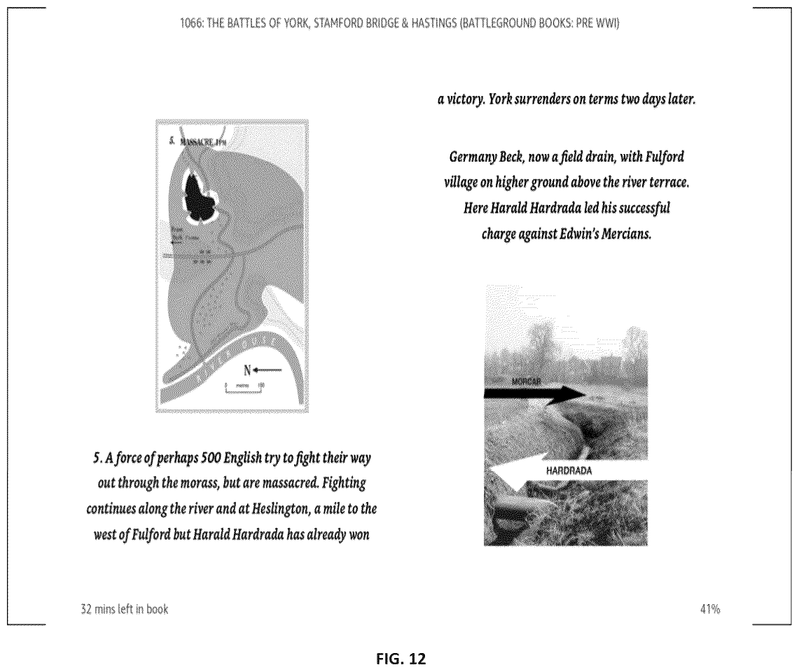

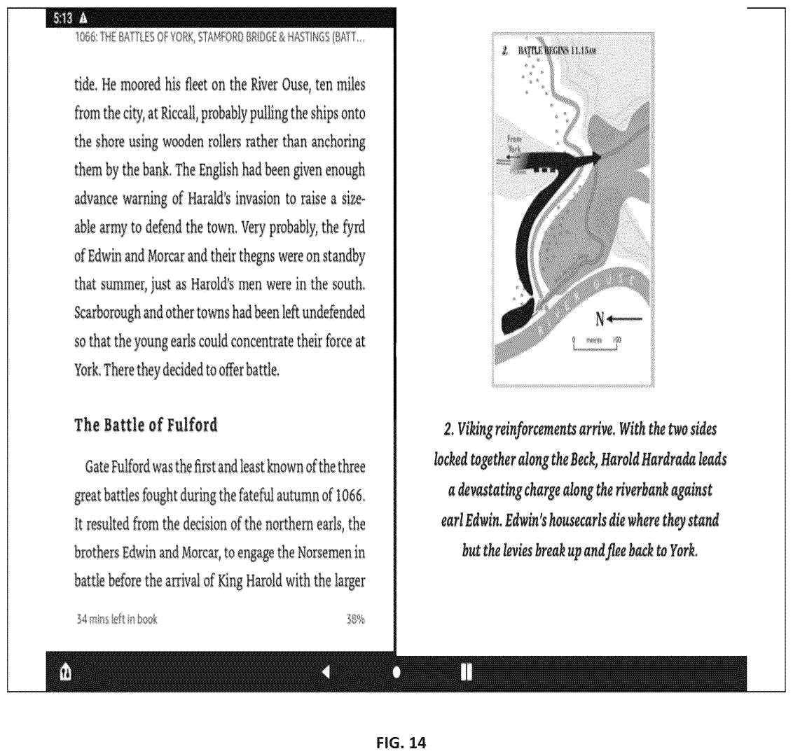

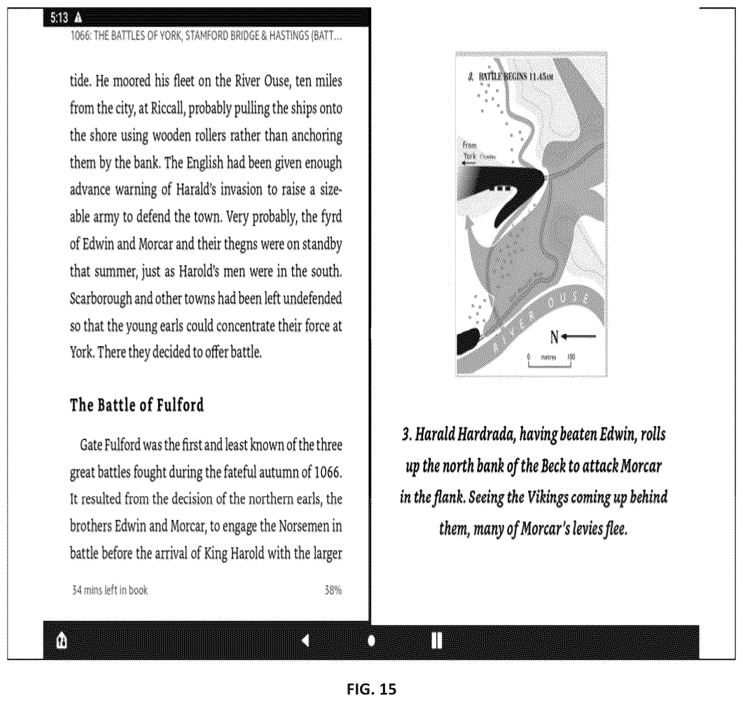

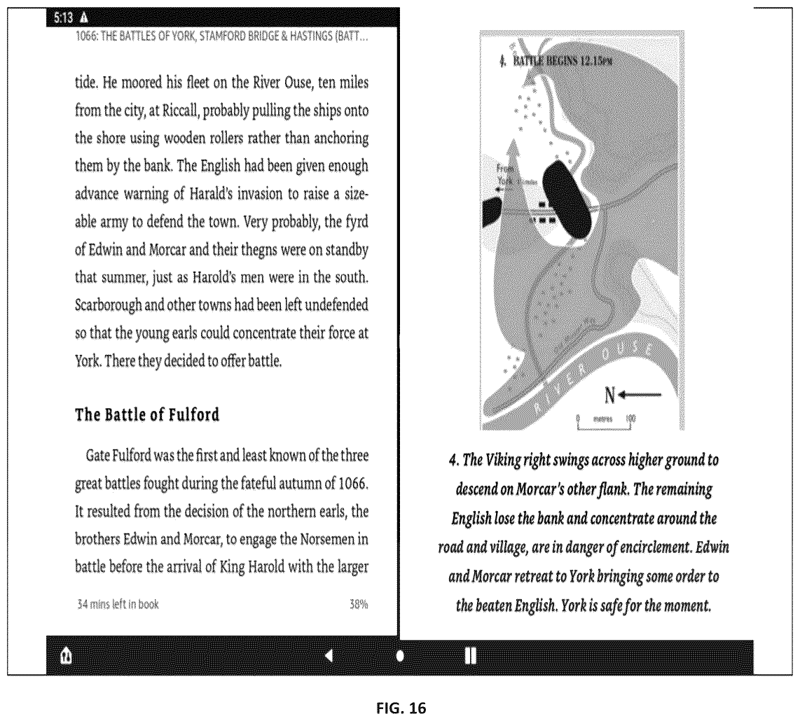

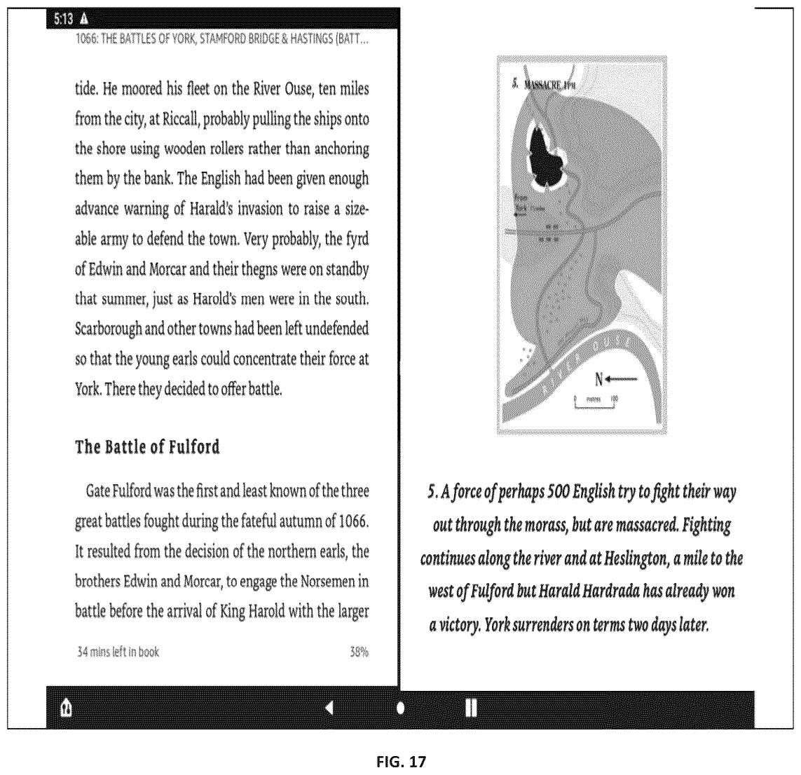

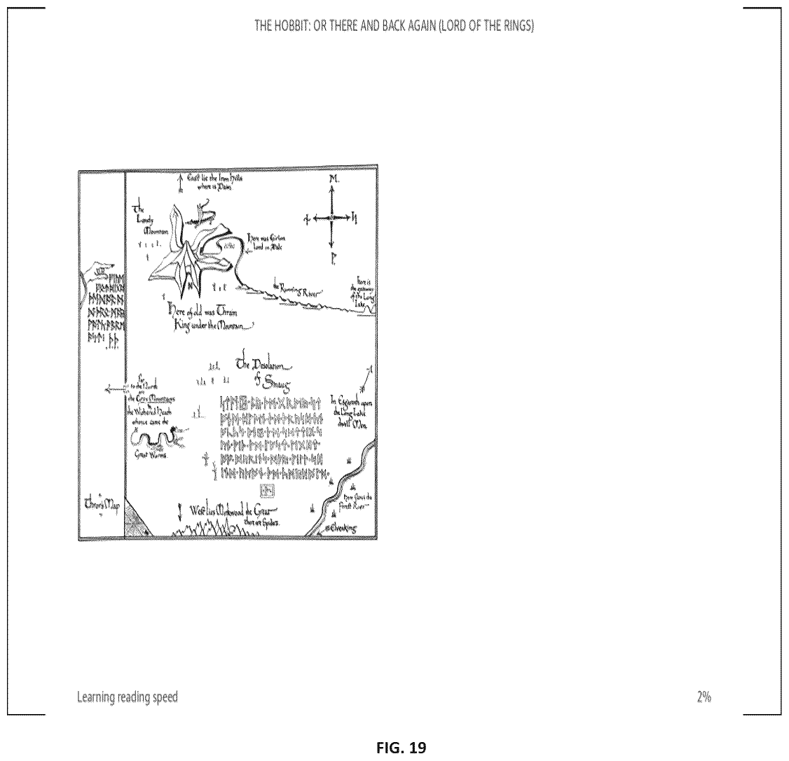

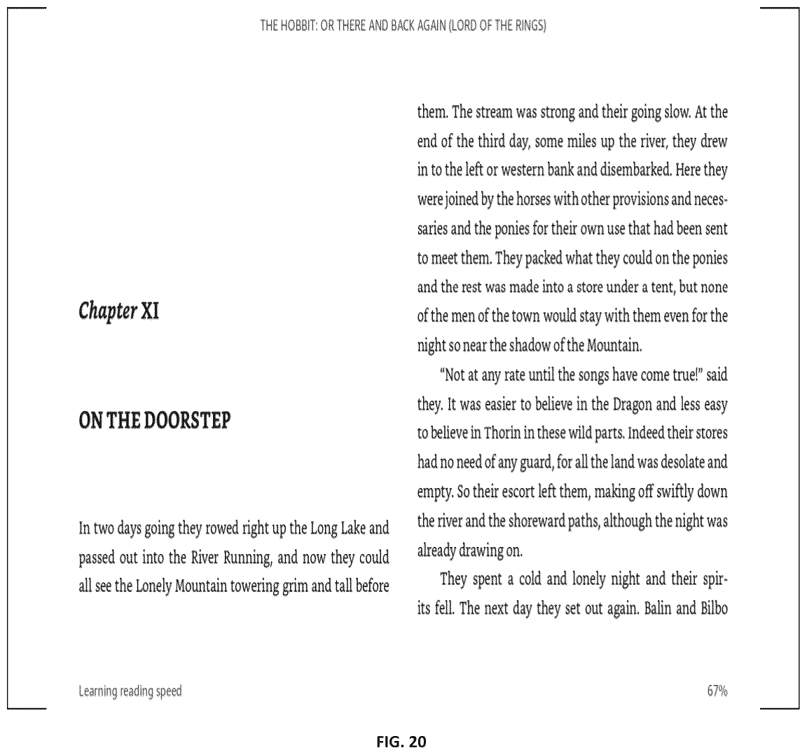

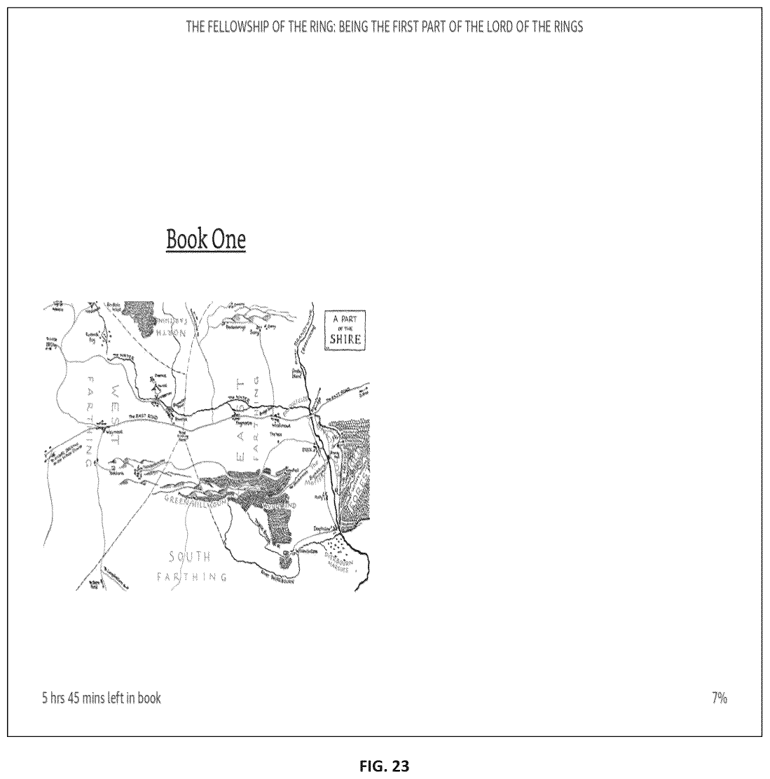

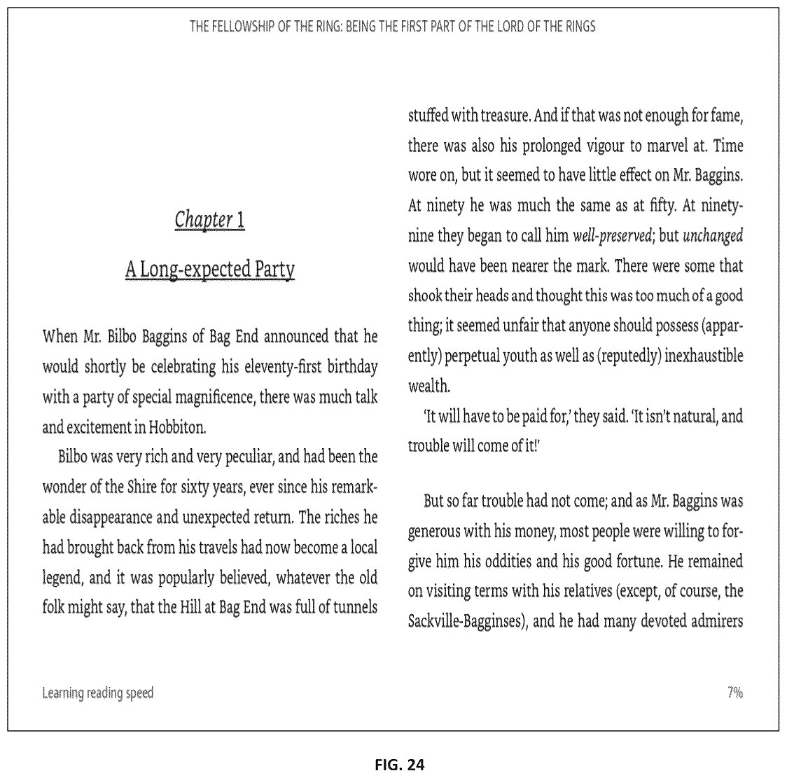

FIGS. 7 through 39 show representative mockups of the I2FEMP consumer environment. These screenshots of digitized publications are shown displaying different layouts and implementation of a dynamic mapping environment for sake of illustration of the I2FEMP consumer environment.

FIGS. 7 through 12 are screenshots taken on a Kindle Fire of pages from the eBook “1066, The Battles of York, Stamford Bridge and Hastings”, by Peter Marren. In the example, the author uses five static maps to demonstrate the movement of troops during the Battle of Fulford.

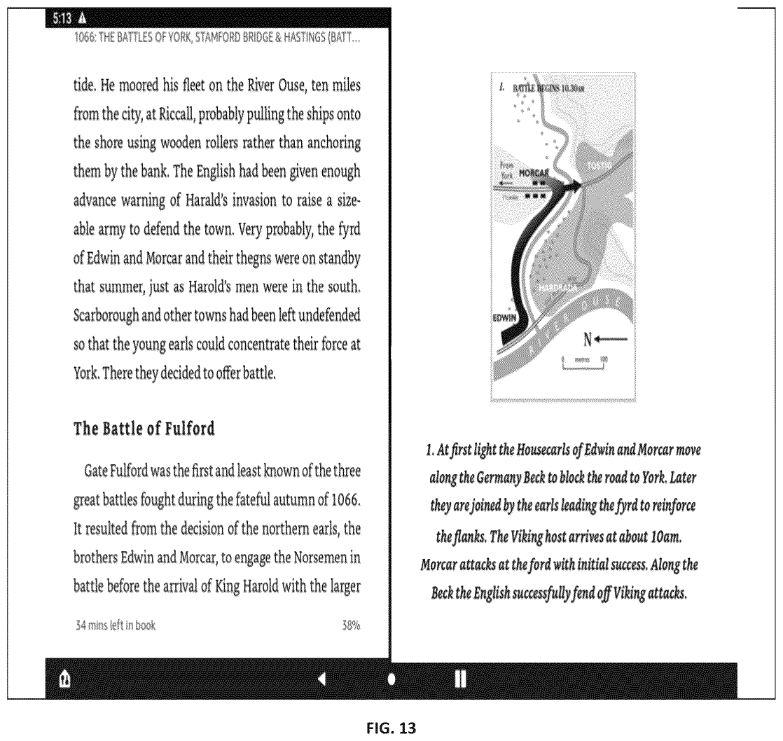

FIGS. 13 through 17 show an embodiment where the eBook is positioned in a left-side text frame with the right-side map frame flipping through the same diagrams with text and/or audio narration to improve consumer comprehension.

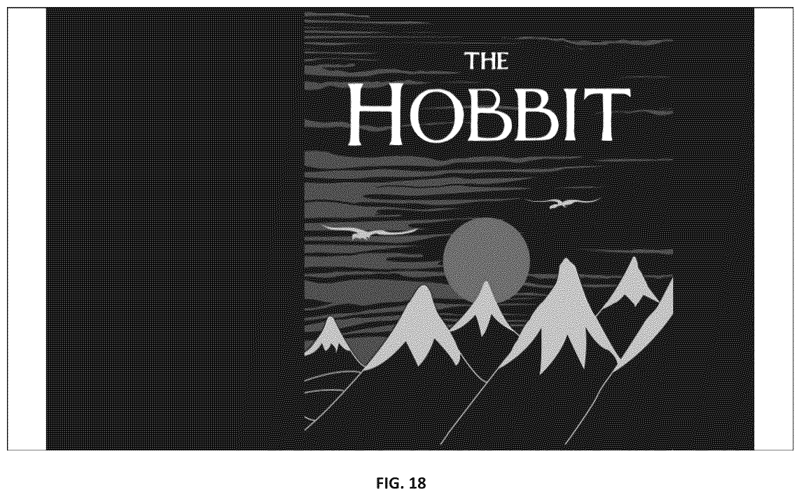

FIGS. 18 through 20 are screenshots taken on a Kindle Fire of pages from “The Hobbit”, by J. R. R. Tolkien. The example demonstrates the disconnection between the map of the area of Mount Doom and the eBook text.

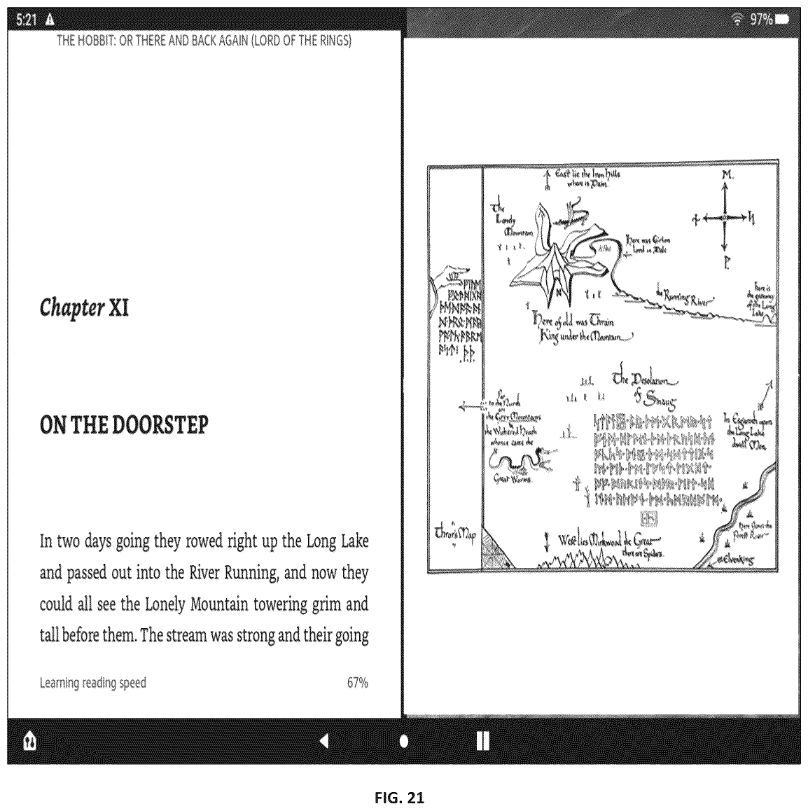

FIG. 21 imagines the eBook text appearing in a left-side text frame with the right-side map frame of the area of Mount Doom using the original book sketch, so that the consumer can continually refer to the map while reading the story as it is describing its geography. The map may remain static or may include user inserted elements via media tags that show for example, character position or events animated on the map.

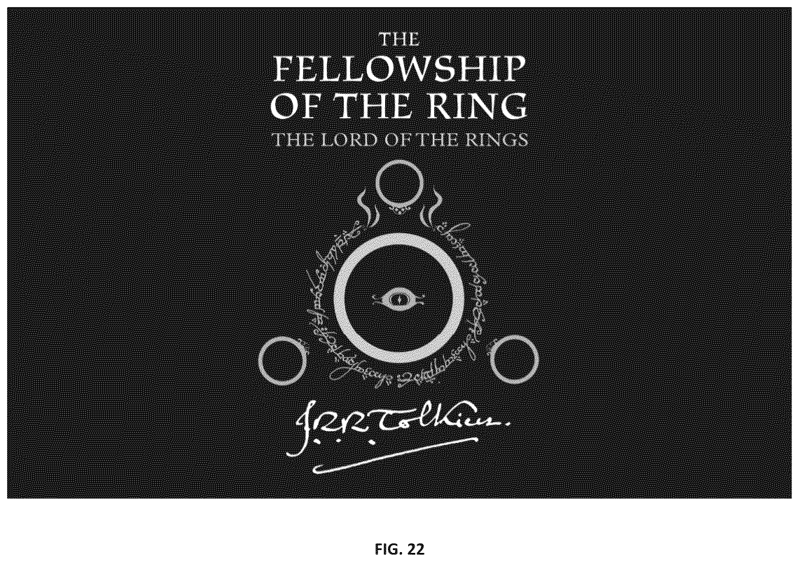

FIGS. 22 through 24 are screenshots taken on a Kindle® Fire® of pages from “The Fellowship of the Ring”, by J. R. R. Tolkien. The example demonstrates the disconnection between the map of the Shire and the eBook text.

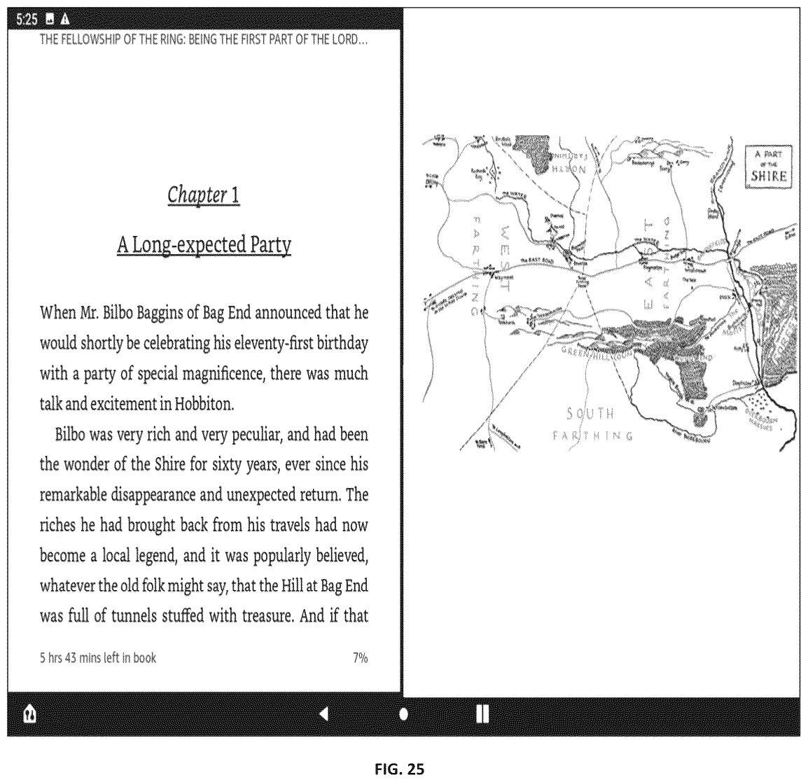

In the embodiment of FIG. 25, the eBook text appears in a left-side text frame with the right-side map frame of the Shire using the original book sketch, so that the consumer can continually refer to the map while reading the story as it is describing the geography.

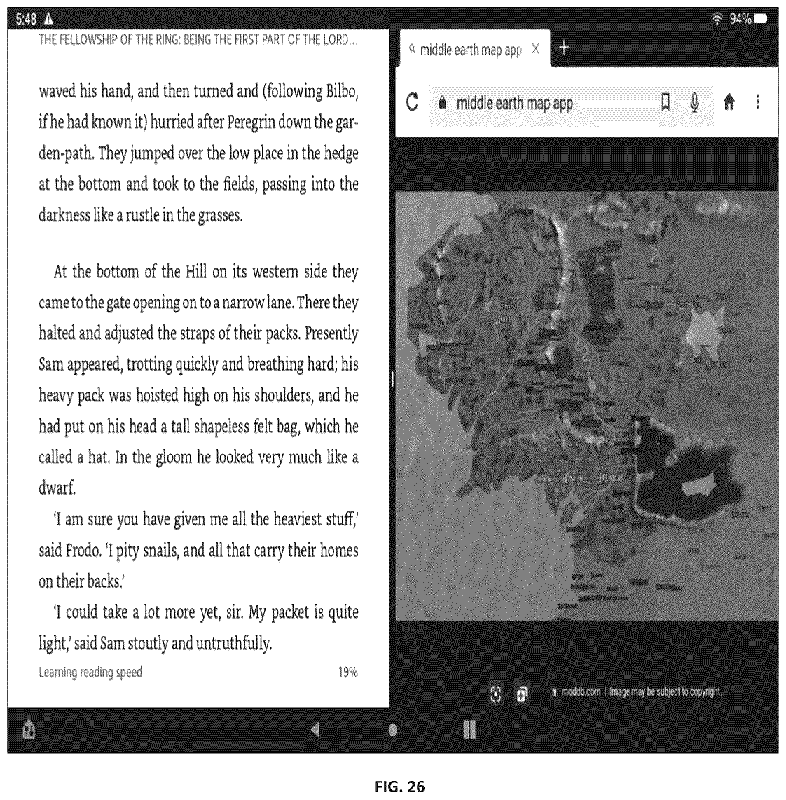

FIG. 26 shows an embodiment where the eBook text appears in a left-side text frame displayed simultaneously with the right-hand map frame displaying an active, dynamic map of “The Fellowship of the Ring” geography that may show animation, be associated with map-synchronized narration, and be directly manipulated by the consumer.

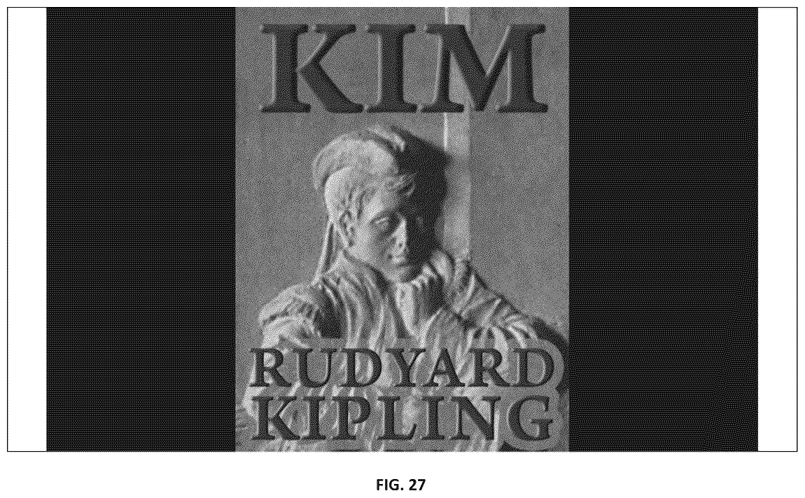

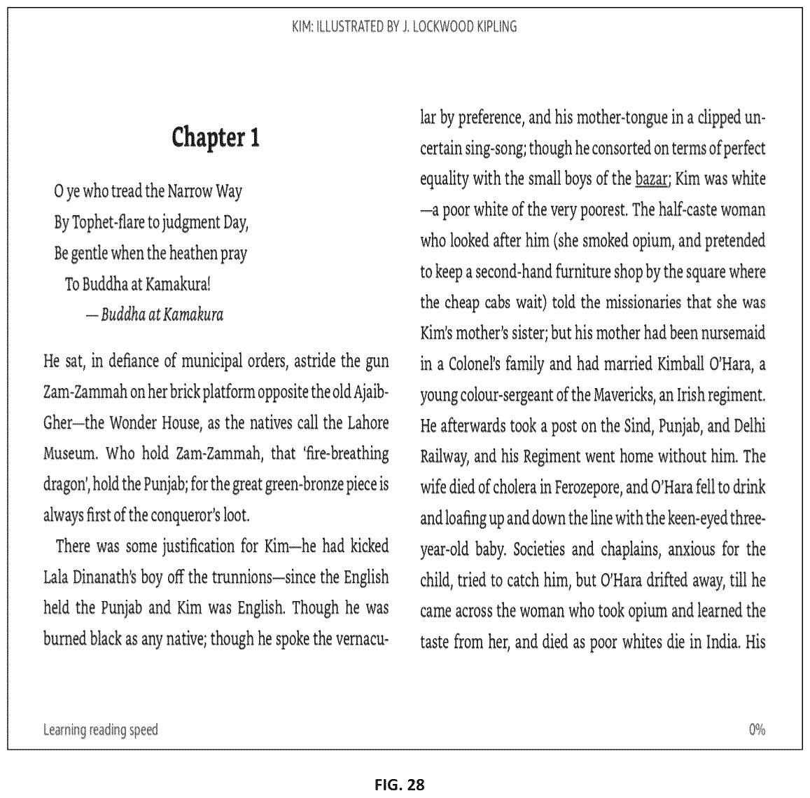

FIGS. 27 and 28 are screenshots taken on a Kindle® Fire® of pages from “Kim”, by Rudyard Kipling, showing no map.

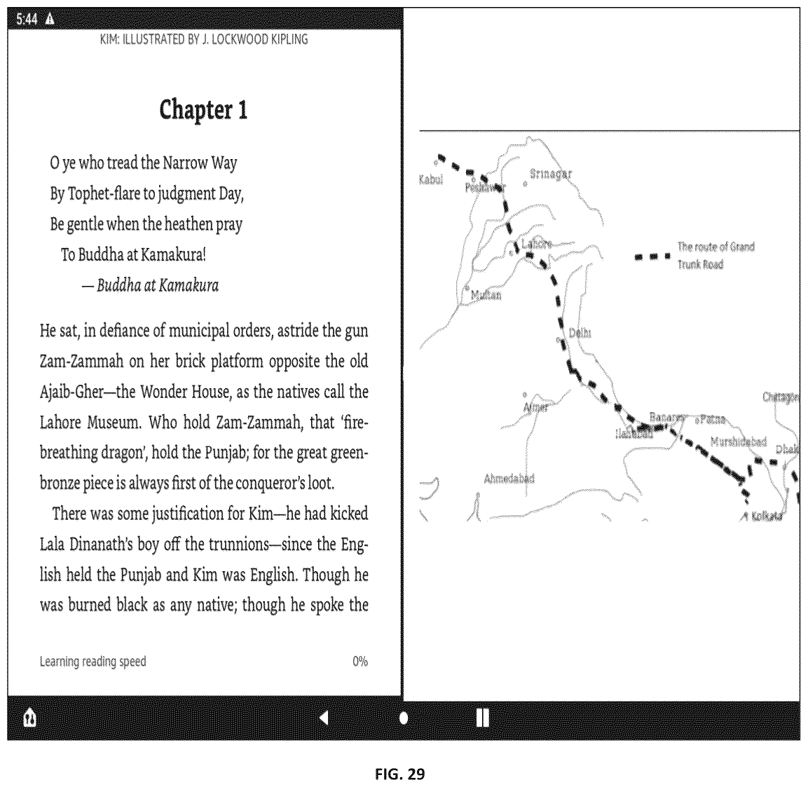

FIG. 29 shows an embodiment with the eBook text appearing in a left-side text frame with the right-hand map frame showing a static map of Kim's journey generated and inserted by a user, (i.e., not typically found in the book but created by a researcher), so that the consumer can continually refer to the map while reading the story as it is describing the journey.

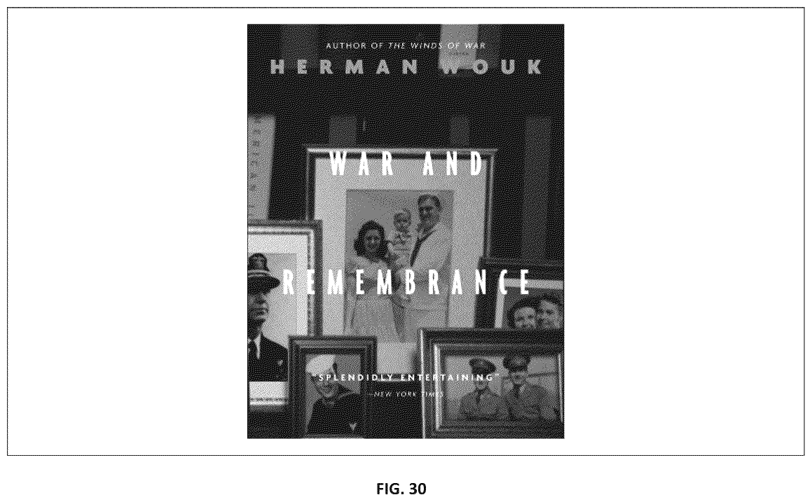

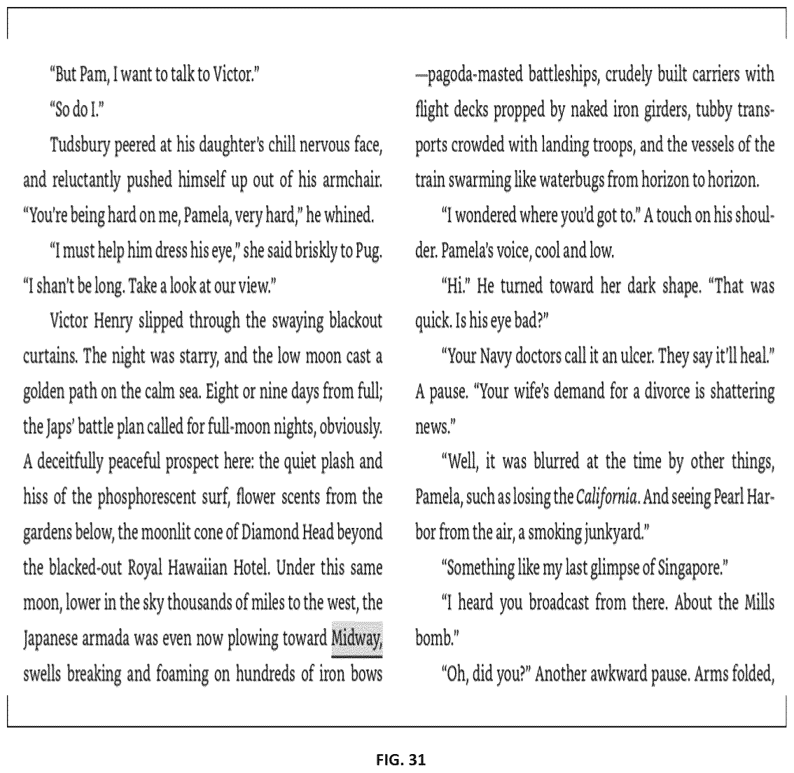

FIGS. 30 and 31 are screenshots taken on a Kindle® Fire® of pages from “War and Remembrance”, by Herman Wouk, showing no map.

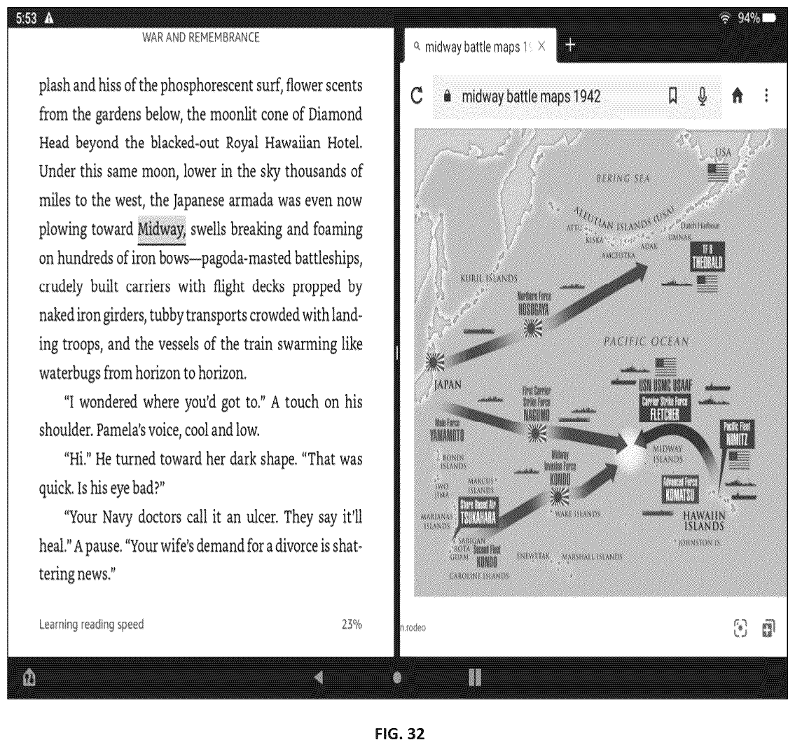

FIG. 32 shows an embodiment with the eBook text appearing in a left-side text frame with the right-hand map frame displaying an active, dynamic map of the Midway battle that displays animation, may be associated with map-synchronized narration, and may be directly manipulated by the consumer.

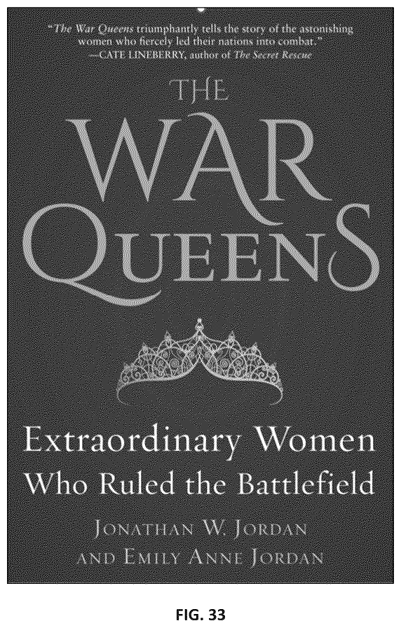

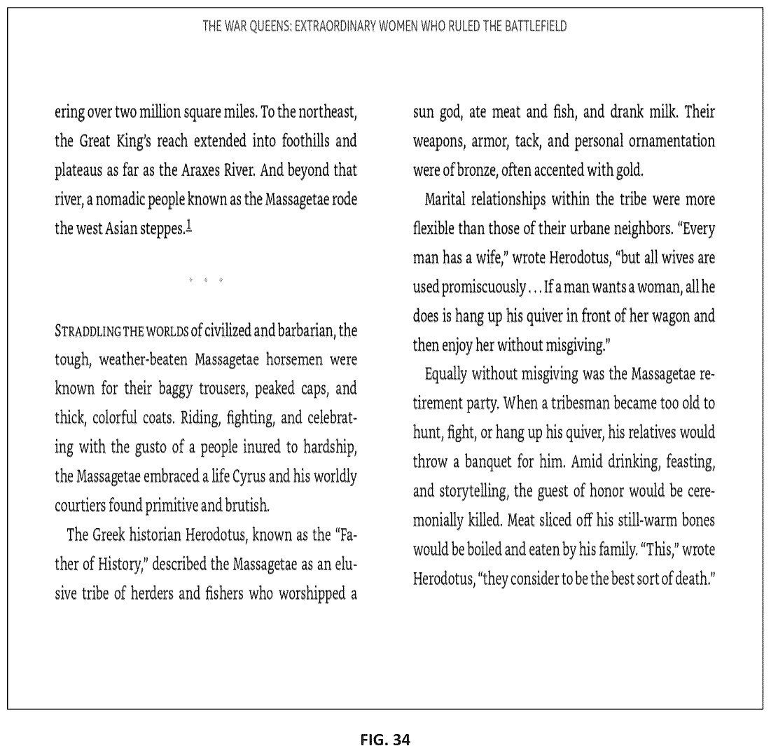

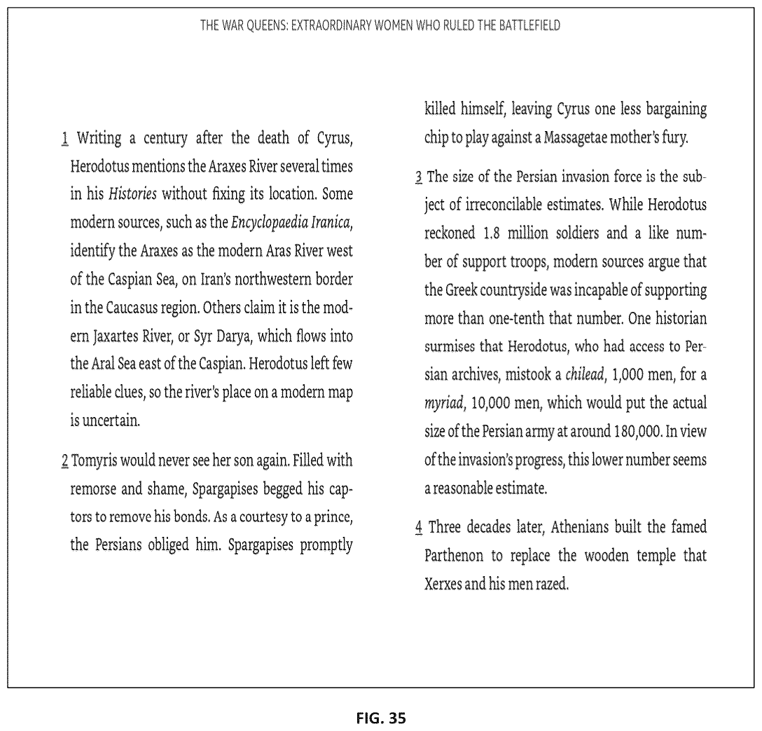

FIGS. 33 through 35 are screenshots taken on a Kindle® Fire® of pages from “The War Queens”, by Jonathan W. Jordan and Emily Anne Jordan. A consumer viewing the eBook page shown on FIG. 34 may be shown an endnote (1). If selected, the consumer may be taken to the footnote page shown in FIG. 35. The consumer may then have to continue going back and forth between the body of the eBook and the footnote content to take advantage of the additional information.

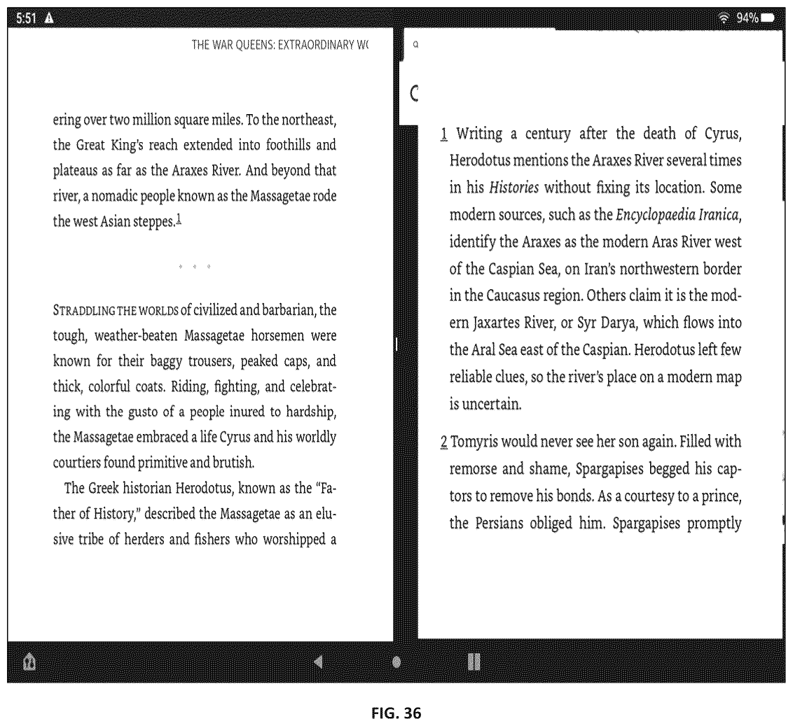

FIG. 36 shows an embodiment with the eBook text appearing in a left-side text frame with the right-hand frame containing the endnote section displaying endnote (1). As the consumer reads the eBook in the left-hand frame, each endnote reference may be selected (or automatically triggered as the case may be), and that endnote may appear on the right-hand frame. In some embodiment, right-hand frame may be empty until the endnote is selected or triggered.

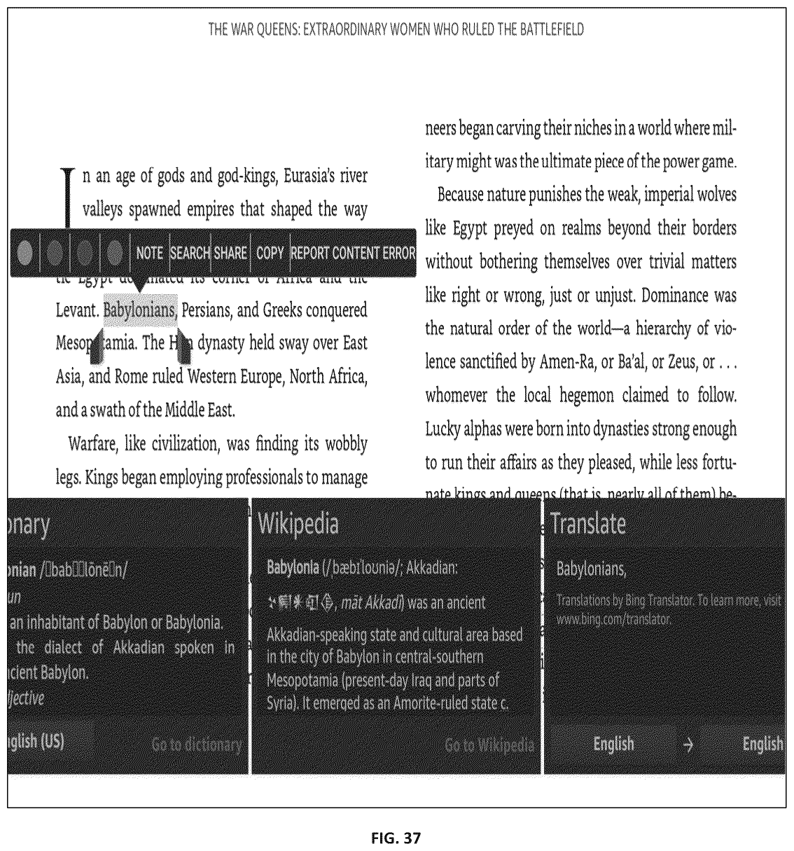

FIGS. 37 through 39 are more screenshots taken on a Kindle® Fire® of pages from “The War Queens”, by Jonathan W. Jordan and Emily Anne Jordan. FIG. 37 shows an embodiment of user interaction with eBook content, where a consumer wanting more reference materials on “Babylonians” highlights the word. In one embodiment, functionality triggers third-party reference resources for display (for example, small overlay windows of a “dictionary”, “Wikipedia”, and/or a translator).

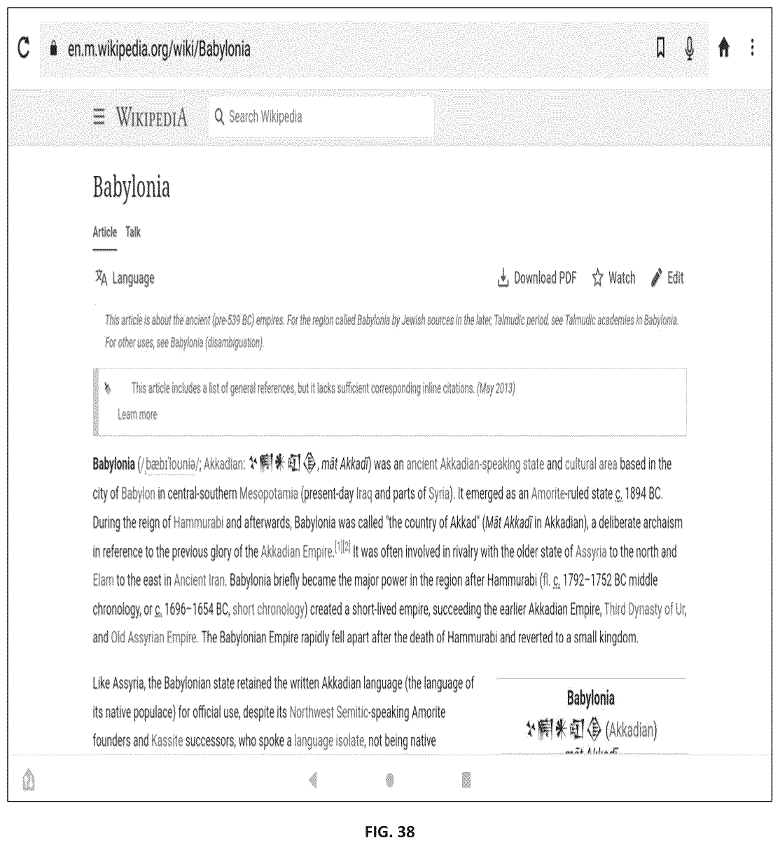

FIG. 38 shows the associated Babylonia Wikipedia screen, where the consumer may browse the Wikipedia information before returning to the eBook content.

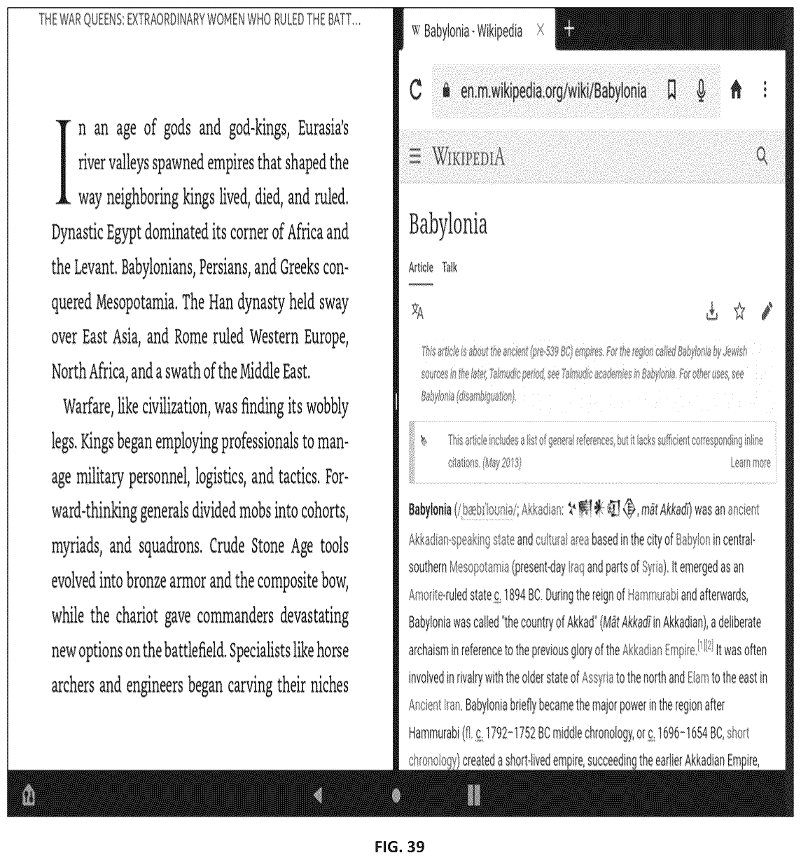

FIG. 39 shows an embodiment with a split screen functionality that includes an internet browser running in the second screen. Any selection to show Wikipedia pages in the left screen refreshes the right screen with that information. Embodiments may include a consumer performing the same function, but with the second frame automatically appearing with the Wikipedia page displayed utilizing I2FEMP.

### Example Hardware and Computer Program Support

In general, references have been made above to processes and use of computing devices for displaying digitally provided reading materials and methods that integrate dynamically changing features in media such as maps or other illustration devices that illustrate progression of a description within a written work. It will be understood that a “computing device” may serve different roles depending on the need in the system or depending on the step being performed in a process. For example, in the role of a web server, a host server, or an online platform server, a computing device may implement the functions related to backend process; for example, accessing third party publisher sites or publication providers, graphics processing of changes to maps, and animation. In the aforementioned roles, the computing device may also coordinate client accounts when providing a service. In the role of a user device, a computing device is generally not a server but may instead be desktop computers, tablet or laptop computers, all-in-one computer stations, a mobile computing device (for example, a smart phone, smart wearable devices (glasses, jewellery, watches, head sets, ear wear, etc.), or programmable electronics. As will be understood, the end user device may generally provide frontend aspects of the system including the user interfaces disclosed above. As a frontend device, a computing device may provide the user interfaces for editing or creating altogether new digital publications. In another role as a frontend device, a computing device may provide the display of digital text and dynamic maps that change with the progression of a consumer reader through text. In some embodiments however, the frontend computing device may perform one or more of the backend steps (for example, graphics processing, code generation, etc.) where possible.

The components of the tablet or laptop computers may include, but are not limited to, one or more processors or processing units, a system memory, data storage, a computer program product having a set of program modules including files and executable instructions, and a bus system that couples various system components including the system memory to the processor(s). The memory storage may store for example, downloaded publications, media files, and executable instructions for embedding into a digital book. Computer system executable instructions, such as the program modules/utility product may represent a software embodiment of the system and processes described generally above. In some embodiments, the program modules include dedicated modules, including for example, a module for generating animation tagged with one or more sections of text.

The computing device may communicate with one or more external devices including for example, a peripheral form of an electronic display which may in some embodiments be configured for tactile response as in a capacitive touch screen display. User input into the display may be registered at the processor and processed accordingly. Other devices may enable the computing device to communicate with one or more other computing devices, either by hardwire or wirelessly. Such communication can occur via input/output (i/o) interfaces/ports.

The computing device, through the I/O interface/ports, may communicate with one or more networks such as a local area network (LAN), a general wide area network (WAN), and/or a public network (e.g., the internet) via a network adapter. In some embodiments, the computing device may be a cloud computing node connected to a cloud computing network. The computer computing device may be practiced in distributed cloud computing environments where tasks are performed by remote processing devices that are linked through a communications network. In a distributed cloud computing environment, program modules may be located in both local and remote computer system storage media including memory storage devices.

Reference to a computer system or server may be described in the general context of computer system executable instructions, such as program modules, being executed by a computer system (described for example, below). In some embodiments, the computer system/server may be a cloud computing node connected to a cloud computing network (not shown). The computer system/server may be practiced in distributed cloud computing environments where tasks are performed by remote processing devices that are linked through a communications network. In a distributed cloud computing environment, program modules may be located in both local and remote computer system storage media including memory storage devices.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) Or an embodiment combining software and hardware aspects that may all generally be referred to herein as a “module”, “circuit”, or “system.” furthermore, aspects of the disclosed invention may take the form of a computer program product embodied in one or more computer readable media having computer readable program code embodied thereon. In some embodiments, the output of the computer program product provides an electronic user interface on the display which may be controlled via direct contact with the display or via the i/o interfaces (which may be for example, interface devices such as keyboards, touchpads, a mouse, a stylus, or the like).

### SUBMISSIONS TO STANDARDS BODIES

The proposed media tag format/function would be submitted as a potential World Wide Web Consortium (W3C) Web standard.

The proposed media behavior executable format/function would be submitted as potentially an Open Geospatial Consortium (OGC) standard.

It is uncertain at this time as to which of the prevalent eBook file formats would be optimal for developing I2FEMP and whether enhancements to the standards would be required to support I2FEMP functionality.

It is uncertain at this time as to which of the prevalent map file formats would be optimal for developing I2FEMP and whether enhancements to a format would be required to support I2FEMP functionality, including spatiotemporal, animation, and map-synchronized narration capabilities.

### 110—Publisher Sources

The expanded concept of Publisher Sources warrants further elucidation. As described earlier, 110—Publisher Sources consist of 1) 111—eBooks, 2) 115—eBook-Specific Media, and 3) 118—Media Ecosystem. 111—eBooks represents the traditional sources of eBooks today, e.g., Kindle® Direct Publishing®.

It is anticipated that 115—eBook-Specific Media would be developed, integrated, and published in association with eBooks in a similar fashion that audio narration (e.g., Audible.com) is currently performed. The Publisher would have control over what eBook-Specific Media are published in conjunction with the associated eBook content.

118—Media Ecosystem is a completely novel concept that would develop over time given an effective community/economic/educational model. The model would stimulate the creation of a community of media sources. Given a robust set of open standards, any individual or organization may create media that would integrate with existing eBooks. An incomplete list of potential media sources includes:
Wikimedia (Source: commons.wikimedia.org)
Reusing—The Wikimedia Foundation owns almost none of the content on Wikimedia sites the content is owned, instead, by the individual creators of it. However, almost all content hosted on Wikimedia Commons may be freely reused subject to certain restrictions (in many cases). You do not need to obtain a specific statement of permission from the licensor(s) of the content unless you wish to use the work under different terms than the license states.
   Content under open content licenses may be reused without any need to contact the licensor(s), but just keep in mind that:
      some licenses require that the original creator be attributed;
      some licenses require that the specific license be identified when reusing (including, in some cases, stating or linking to the terms of the license);
      some licenses require that if you modify the work, your modifications must also be similarly freely licensed; and finally.
   Content in the public domain may not have a strict legal requirement of attribution (depending on the jurisdiction of content reuse), but attribution is recommended to give correct provenance.
Contributing—Wikimedia Commons only accepts free content, that is, images and other media files that are not subject to copyright restrictions which would prevent them being used by anyone, anytime, for any purpose. Wikimedia Commons only accepts media:
   that are explicitly freely licensed, or
   that are in the public domain in at least the United States and in the source country of the work.
Google Maps Platform
   Supports Maps, Routes, and Places
   Google Earth Engine
   Public Data Catalog
   Amazon
   Cartography Vectors—Providing thousands of vector mapping files that span the entire globe. From continents, to cities, countries, cities, lakes, oceans, time zones, and more, we have it all. If you can name it, we probably have a mapping file for it!(https://cartographyvectors.com/)
   Quadrigram—Download any map for free to include in your data project. Quadrigram's choropleth maps work with SVG files. (https://www.quadrigram.com/maps/)
   MAPSVG—Download free SVG vector maps. (https://mapsvg.com/maps)
   AMCharts—All maps are available for free for non-commercial use under Creative Commons Attribution-NonCommercial 4.0 International License. For commercial use please consider acquiring an amCharts 4 license. (https://www.amcharts.com/svg-maps/)
   National Geographic
   United States National Archives
   Encyclopaedia Britannica
   Universities
   Governments
   Non-Government Organizations
   Cartography Organizations
   Individuals

Associating maps from a media ecosystem source to an eBook could be performed by the publisher, which would result in the maps being downloaded and integrated with the eBook content for consumer consumption.

A novel capability would be the ability of an eBook consumer to choose the maps to be associated with a given eBook. This would open the entire media ecosystem to eBook consumers.

For media related to but not specifically designed for given eBooks, I2FEMP would support pointing from the eBook media tags to media behavior executables of a configurable set of maps. In other words, it must support identical behavior independent of which set of media it is pointing to from an eBook.

### Map Development Environment 122

It is uncertain at this time as to which of the prevalent mapping applications would be feasible for developing the I2FEMP maps. It could be one or more, depending on the mapping format selected for representing the maps, animations, and map-synchronized narration in the Media Frame and the functionality supported.
Map Author actions
   Design/build reference maps specific to the eBook content.
   Reuse free or licensed compatible maps.
   Design/build spatiotemporal overlays.
   Build animations.
   Associate audio clips with eBook content and map animations
Author Map Menu commands
   File Tools
      New, Open, Save, Save As, Print, Export, Share, Close
   Spatial Tools
   Temporal Tools
   Animation Tools
   Audio Tools
eBook Text Editing Author actions
   During eBook and dynamic mapping development, add links and unique calls between text in the text frame and map(s) appearing in the media frame.

### TECHNICAL ADVANCES AND ECONOMICAL SIGNIFICANCE

The present disclosure described herein above has several technical advantages including, but not limited to, the realization of a system and a method for creating an integrated eBook content and media environment that:
Is easy to use.
Improves an eBook consumer's experience and understanding of the eBook content through the use of supplemental media content.
Can create and reuse spatiotemporal maps.
Enables tagging of media to eBook contents between text and media.
Supports multimedia in the media frame.
Supports eBook-encoded endnotes, tables, and figures in the media frame.
Supports Dictionary links in the media frame.
Supports Wikipedia links in the media frame
Enhances user visualization experience.
Supports map navigation.
Is compatible with any digital media device.

Examples of categories of books with examples that would benefit from the I2FEMP technology include:
Geographical and journey-based novels, such as “Kim”, “Winds of War”, “War and Remembrance”, the Tolkien books, “The Iliad”, “The Odyssey”, “Musashi”, “Don Quixote”, “Shogun”, “Taipan”, the Hornblower series, the Aubrey/Maturin series,
Geographical and journey-based non-fiction, such as “The Rise and Fall of the Roman Empire”, Churchill's “History of World War II”, the hundreds of books on Waterloo and 1066, “Japan: The Story of a Nation”, and “1776”.
Travel books, such as Lonely Planet, Fodors, Marco Polo, and Rick Stevens.
Any book that contains historical placenames that have disappears or changed over time, such as Istanbul, formerly known as Constantinople, formerly known as Byzantium, and Tokyo, formerly known as Edo.
Any book that relies heavily on endnotes, figures or tables, such as “The New Oxford Annotated Bible with Apocrypha”, “The Complete Works of William Shakespeare (Annotated)”, “The Cambridge Centenary Ulysses: The 1922 Text with Essays and Notes”, and “The Annotated Arabian Nights”.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, or group of elements, but not the exclusion of any other element, or group of elements.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1. A computer program product for generating enhanced media in a digital book, the computer program product comprising a non-transitory computer readable storage medium having computer readable program code embodied therewith, the computer readable program code being configured, when executed by a processor, to:
receive a downloaded text file of a publication;
generate a first user interface, wherein text of the downloaded text file is viewable by a user;
receive a media file related to the text of the downloaded text file;
tag a point in the text;
receive an executable instruction embedded in the tagged point in the text, wherein the executable instruction performs a dynamic change in the media file;
display the downloaded text into a digital readable format, wherein the downloaded text incorporates the executable instruction in the tagged point along with the media file in the digital book; and
perform the executable instruction upon a triggering event associated with the tagged point in the text, wherein performing the executable instruction performs a display of the dynamic change in the media file in the digital book format.

2. The computer program product of claim 1, wherein the media file is a map.

3. The computer program product of claim 2, wherein the dynamic change in the map includes displaying a change in an appearance of map features in the map.

4. The computer program product of claim 2, wherein the dynamic change in the map includes animation of map features in the map.

5. The computer program product of claim 4, wherein the animation correlates to a text passage describing the animation in the text.

6. The computer program product of claim 1, wherein the computer readable program code is further configured to:
generate a visual representation of the tagged point in the text, wherein:
the visual representation is selectable by a reader; and
the triggering event is a selection of the visual representation by the reader.

7. The computer program product of claim 6, wherein the visual representation of the tagged point in the text is one of a stylized font that differs from adjacent font, superscripted or subscripted font, or an icon positioned adjacent the tagged point in the text.

8. The computer program product of claim 1, wherein the computer readable program code is further configured to:
narrate the text;
identify the tagged point in the text during narration; and
display the dynamic change in the media file synchronized with narration of the identified tagged point in the text.

9. The computer program product of claim 1, wherein the computer readable program code is further configured to receive a user generated map including map features correlated with a text passage in the text, wherein the executable instruction is associated with one or more of the map features in the user generated map.

10. A user interface platform for digital books, comprising:
a first user interface, wherein the first user interface includes:
a digital book download portal, and
a media development interface, wherein an author user generates a media file or modifies a pre-generated media file, that includes content associated with a digital book downloaded through the digital book download portal; and
a second user interface, wherein the second user interface includes a first frame displaying text of the digital book downloaded through the digital book download portal and displays the author user generated media file or modified pre-generated media files.

11. The user interface platform of claim 10, wherein the author user generated media file or modified pre-generated media file is a map of content described in the text of the digital book downloaded through the digital book download portal.

12. The user interface platform of claim 10, wherein the author user generated media file or modified pre-generated media file is a video of content described in the text of the digital book downloaded through the digital book download portal.

13. The user interface platform of claim 10, further comprising a first function in the first user interface, wherein the first function is configured to receive an executable instruction embedded in the text of the digital book.

14. The user interface platform of claim 13, wherein the executable instruction embedded in the text of the digital book is configured to perform a dynamic change in the author user generated media file or modified pre-generated media file.

15. The user interface platform of claim 14, wherein:
the first user interface includes a second function configured to generate a visual representation of the executable instruction embedded in the text of the digital book, and
the executable instruction is triggered in response to a reader user interacting with the visual representation of the executable instruction embedded in the text of the digital book.

16. The user interface platform of claim 13, wherein:
the second user interface includes a narration function configured to audibly narrate the text of the digital book;
the second user interface includes an automated feature that, upon a computer processor detecting a position of the executable instruction embedded in the text of the digital book, the computer processor triggers the executable instruction upon determining that a narration has reached the detected position of the executable instruction embedded in the text of the digital book.

17. The user interface platform of claim 13, wherein:
the executable instruction embedded in the text of the digital book is configured to open a web page displayed in the second user interface; and
the web page shows content related to the text of the digital book.

18. The user interface platform of claim 10, wherein:
the second user interface includes a second frame demarcated from the first frame;
the first frame is dedicated to displaying the text of the digital book; and
the second frame displays the author user generated media file or modified pre-generated media file.

19. The user interface platform of claim 18, wherein the author user generated media file or modified pre-generated media file changes appearance in the second frame in relation to a reader user progressing through the text of the digital book in the first frame.

20. The user interface platform of claim 18, wherein the author user generated media file or modified pre-generated media file remains visible in the second frame as a reader user progresses through multiple pages of the text of the digital book in the first frame.
